(19) United States
(12) Patent Application Publication
(10) Pub. No.: US 2026/0029044 A1
(43) Pub. Date: Jan. 29, 2026

(54) LINEAR ACTUATOR

(71) Applicant: Neon Aero, Inc., Wilmington, DE (US)

(72) Inventor: Benjamin Essenburg, Irvine, CA (US)

(21) Appl. No.: 19/252,050

(22) Filed: Jun. 27, 2025

Related U.S. Application Data
(60) Provisional application No. 63/665,300, filed on Jun. 28, 2024.

(51) Int. Cl. F16H 25/20; F16H 25/22

(52) U.S. Cl. CPC F16H 25/2056; F16H 25/2228; F16H 2025/2062

(57) ABSTRACT

A linear actuator including a first actuator member, a second actuator member, and a third actuator member. The linear actuator also includes a first threaded interface between the first actuator member and the second actuator member configured to produce relative linear movement of the first actuator member and the second actuator member along an actuation direction during rotational actuation of the first threaded interface. The linear actuator further includes a second threaded interface between the second actuator member and the third actuator member configured to produce relative linear movement of the second actuator member and the third actuator member along the actuation direction during rotational actuation of the second threaded interface.

### CROSS-REFERENCE TO RELATED APPLICATIONS

This application claims the benefit of U.S. provision patent application Ser. No. 63/665,300, filed on 28 Jun. 2024, entitled “SERIES REDUNDANT JAM PROOF LINEAR ACTUATOR,” the entire disclosure of which is incorporated herein by reference.

### TECHNICAL FIELD

The present disclosure generally relates to actuators, and more particularly relates to linear actuators providing redundancy protection against jamming.

### BACKGROUND

Linear actuators are utilized in a wide variety of applications, including motor vehicle applications, aircraft applications, and aerospace applications. All such linear actuators represent a tradeoff between performance, reliability, cost, size, and a multitude of other considerations. Particularly, in aircraft and aerospace application size, weight, and reliability may be of particular importance. As such, many endeavors have been made to provide reliable actuators that may be relatively light and compact.

### SUMMARY

According to an implementation, a linear actuator may include a first actuator member, a second actuator member, and a third actuator member. A first threaded interface may be provided between the first actuator member and the second actuator member. The first threaded interface may be configured to produce relative linear movement of the first actuator member and the second actuator member along an actuation direction during rotational actuation of the first threaded interface. A second threaded interface may be provided between the second actuator member and the third actuator member. The second threaded interface may be configured to produce relative linear movement of the second actuator member and the third actuator member along the actuation direction during rotational actuation of the second threaded interface.

One or more of the following features may be included. The first threaded interface may include an external thread associated with the first actuator member and an internal thread associated with the second actuator member. The second threaded interface may include an external thread associated with the second actuator member and an internal thread associated with the third actuator member. The first threaded interface and the second threaded interface may include opposite thread directions. The first threaded interface and the second threaded interface may be coaxial.

The first threaded interface may include a ball screw interface. The second threaded interface may include a ball screw interface. The first threaded interface and the second threaded interface may include a compound coaxial ball screw associated with the second actuator member. The compound coaxial ball screw may include two independent ball circuits. The two independent ball circuits may include an inner ball circuit forming at least a portion of the first threaded interface with the first actuator member. The two independent ball circuits may include an outer ball circuit forming at least a portion of the second threaded interface with the third actuator member.

The linear actuator may further include one or more of a first rotational actuator for rotating the first actuator member, a second rotational actuator for rotating the second actuator member, and a third rotational actuator for rotating the third actuator member. The linear actuator may further include one or more of a first carrier mounting the first rotational actuator, a second carrier mounting the second rotational actuator, and a third carrier mounting the third rotational actuator. The first carrier, the second carrier, and the third carrier may be mutually telescoping along the actuation direction. The first carrier may be rotationally constrained relative to the second carrier. The second carrier may be rotationally constrained relative to the third carrier.

According to another implementation, a linear actuator may include an at least partially threaded shaft rotationally drivable by a first rotational actuator. The linear actuator may also include an intermediate shell rotationally drivable by a second rotational actuator. The intermediate shell may include an at least partially threaded interior opening forming a first threaded interface with the at least partially threaded shaft. The intermediate shell may also include an at least partially threaded exterior component. The linear actuator may also include an outer shell rotationally drivable by a third rotational actuator. The outer shell may have an at least partially threaded interior opening forming a second threaded interface with the at least partially threaded exterior component of the intermediate shell.

One or more of the following features may be included. The first threaded interface and the second threaded interface may include opposite thread directions. The at least partially threaded interior opening of the intermediate shell may include a nut forming the first threaded interface with the at least partially threaded shaft. The at least partially threaded interior opening of the outer shell may include a nut forming the second threaded interface with the at least partially threaded exterior component of the intermediate shell. The intermediate shell may include a compound coaxial ball screw. The compound coaxial ball screw may include an inner ball circuit forming at least a portion of the first threaded interface with the at least partially threaded shaft. The compound coaxial ball screw may include an outer ball circuit forming at least a portion of the second threaded interface with the third actuator member.

The linear actuator may include a first carrier mounting the first rotational actuator. The linear actuator may include a second carrier mounting the second rotational actuator. The linear actuator may also include a third carrier mounting the third rotational actuator. The first carrier may be rotationally constrained relative to the second carrier. The second carrier may be rotationally constrained relative to the third carrier. The first carrier and the second carrier may include a telescoping splined interface. The second carrier and the third carrier may include a telescoping splined interface.

### BRIEF DESCRIPTION OF THE DRAWINGS

FIG. 1 is a schematic cross-sectional view of a portion of a linear actuator, according to an example embodiment;

FIG. 2 schematically depicts the linear actuator of claim 1, according to an example embodiment;

FIG. 3 schematically depicts a portion of a linear actuator, according to an example embodiment;

FIGS. 4 through 6 depict various cross-sectional views of a compound coaxial ball screw assembly, according to an example embodiment;

FIG. 7 is an exploded view of a compound coaxial ball screw assembly, according to an example embodiment;

FIGS. 8A and 8B are cross-sectional views of a compound coaxial ball screw assembly, according to an example embodiment;

FIGS. 9A and 9B are cross-sectional views of a compound coaxial ball screw assembly, according to an example embodiment;

FIGS. 10A and 10B depict example ball nut configurations that may be utilized in connection with a compound coaxial ball screw assembly, accordingly to an example embodiment;

FIGS. 11A through 11C depict various views of a multi-ball circuit compound coaxial ball screw assembly, accordingly to an example embodiment;

FIS. 12A and 12B depict various operational details of a compound coaxial ball screw assembly; according to an example embodiment;

FIG. 13 is a schematic depiction of a linear actuator, according to an example embodiment;

FIG. 14 is a schematic depiction of a linear actuator, according to an example embodiment;

FIG. 15 is a schematic depiction of a linear actuator, according to an example embodiment;

FIGS. 16A through 16C schematically depict the operation of a linear actuator, according to an example embodiment;

FIG. 17 is a functional block diagram of a linear actuator, according to an example embodiment;

FIG. 18 is a failure mode matrix for a linear actuator, according to an example embodiment;

FIG. 19 is a functional block diagram of a linear actuator, according to an example embodiment;

FIG. 20 is a functional block diagram of a failure state of a linear actuator, according to an example embodiment;

FIG. 21 is a functional block diagram of a failure state of a linear actuator, according to an example embodiment;

FIG. 22 is a functional block diagram of a failure state of a linear actuator, according to an example embodiment;

FIG. 23 is a functional block diagram of a failure state of a linear actuator, according to an example embodiment;

FIGS. 24A through 24C schematically depict the operation of a linear actuator in a failure state, according to an example embodiment;

FIGS. 25A through 25C schematically depict the operation of a linear actuator in a failure state, according to an example embodiment;

FIG. 26 is a functional block diagram of a failure state of a linear actuator, according to an example embodiment;

FIGS. 27A through 27C schematically depict the operation of a linear actuator in a failure state, according to an example embodiment; and

FIGS. 28A through 28C schematically depict the operation of a linear actuator in a failure state, according to an example embodiment.

### DETAILED DESCRIPTION OF EXAMPLE EMBODIMENTS

In general, the present disclosure relates to actuators, and more particularly to linear actuators. While actuators according to the present disclosure may be used in a wide variety of applications, in some example embodiments actuators disclosed herein may be used in connection with aircraft and aerospace applications. Consistent with some illustrative example embodiments, linear actuators consistent with the present disclosure may provide redundancy that may allow complete cycling of the actuator even if certain components jam or otherwise fail.

Consistent with embodiments of the present disclosure, an actuator may include two or more actuator stages, wherein each actuator stage may include at least one threaded interface such that rotation of one, or both, components of each of the threaded interfaces may provide linear movement along an actuation direction (e.g., either in an extension direction or a retraction direction). Consistent with some implementations, each of the actuator stages may be capable of independently moving the actuator between a fully retracted position and a fully extended position, and vice versa. Accordingly, such an example actuator may be capable of achieving full travel, or movement, of the actuator even in the case of a partial jam (e.g., restriction of linear travel of one of the actuator stages and/or rotational movement of one of the threaded interfaces) and/or partial failure (e.g., electrical and/or mechanical failure of one or more actuator motors). As will be discussed in greater detail below, consistent with the present disclosure, a linear actuator may include more than two actuator stages, e.g., arranged in a similar series arrange as an actuator including two stages.

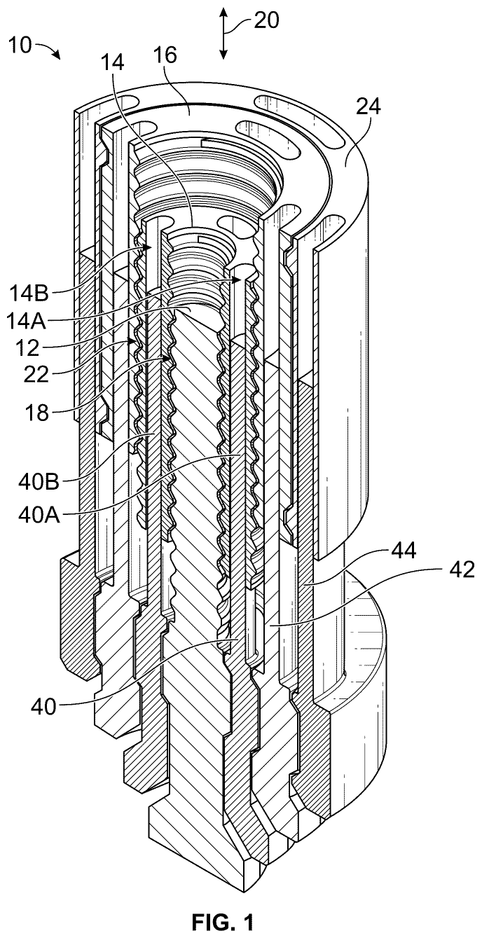

Referring also to FIG. 1, an illustrative example embodiment of an actuator 10 consistent with the present disclosure is schematically illustrated. As generally depicted, the actuator 10 may generally include a first actuator member 12 (also referenced in this disclosure, accompanying tables, and drawings by reference “pink”), a second actuator member 14 (also referenced in this disclosure, accompanying tables, and drawings by reference “orange”), and a third actuator member 16 (also references in this disclosure, accompanying tables, and drawings by reference “green”). As further shown in the example embodiment, the linear actuator 10 may include a first threaded interface 18 (also herein referred to as “pink-orange”) provided between the first actuator member 12 and the second actuator member 14. As discussed in greater detail below, the first threaded interface 18 may be configured to produce relative linear movement of the first actuator member 12 and the second actuator member along an actuation direction (e.g., either toward an extended position or toward a retracted position along direction 20 in the illustrated example embodiment) during rotational actuator of the first threaded interface 18. Further, the actuator 10 may also include a second threaded interface 22 (“orange-green”) provided between the second actuator member 14 and the third actuator member 16. The second threaded interface 22 may be configured to produce relative linear movement of the second actuator member 14 and the third actuator member 16 along the actuation direction 20 during rotational actuation of the second threaded interface 18.

Consistent with the foregoing illustrative example, in some embodiments of the linear actuator 10 the first threaded interface 18 may include an external thread associated with the first actuator member 12 and an internal thread associated with the second actuator member 14. Consistent with such an arrangement, rotational actuation of the first threaded interface 18 may be achieved by relative rotation of the first actuator member 12 (i.e., including external threads, in the illustrated example embodiment) and the second actuator member 14 (e.g., including internal threads in the illustrated example embodiment). Relative rotation of the first threaded interface may include, e.g., rotation of the first actuator member 12, while the second actuator member 14 remains rotationally stationary (and/or rotates in the same direction as the first actuator member 12, but at a different rotational speed than the first actuator member 12). Conversely, relative rotation of the first actuator member 12 and the second actuator member 14 may include rotation of the second actuator member 14, while the first actuator member 12 remains rotationally stationary (and/or rotates in the same direction as the second actuator member 14 but at a different rotational speed than the second actuator member 14). Further, relative rotation of the first actuator member 12 and the second actuator member 14 may include rotation of the first actuator member 12 in a first direction and rotation of the second actuator member 14 in the opposite direction.

Consistent with the foregoing, rotational actuation of the first threaded interface 18 may produce relative linear movement of the first actuator member 12 and the second actuator member 14 along the actuation direction as the internal threads of the second actuator member 14 tighten or loosen on the external threads of the first actuator member 12, and/or the external threads of the first actuator member 12 tighten or loosen within the internal threads of the second actuator member 12. Depending upon the direction of relative rotation, the relative linear movement may be either forward or backward (e.g., which may, in some implementations respectively correspond to an extension direction and a retraction direction of the actuator, or vice versa). For example, if the first threaded interface includes righthand threads, rotational actuation including relative counterclockwise movement of the second actuator member 14 relative to the first actuator member 12 (e.g., as viewed from the top end of the first actuator member 12 in FIG. 1) may result in linear movement in the upward direction (loosening) in FIG. 1. Consistent with the foregoing discussion, the example relative counterclockwise movement of the second actuator member 14 relative to the first actuator member 12 may be accomplished via rotation of the first actuator member 12, the second actuator member 14, and or both the first actuator member 12 and the second actuator member 14. Conversely, relative linear movement in the downward direction of FIG. 1 (e.g., tightening of the second actuator member 14 relative to the first actuator member 10) may be achieved by relative clockwise rotation of the second actuator member 14 with respect to the first actuator member 12.

Consistent with an illustrative example embodiment, the first actuator member 12 may be fixed and/or constrained in the actuation direction relative to, e.g., an actuator housing, a mounting feature, etc. Further, the second actuator member 14 may be capable of linear movement in the actuation direction (e.g., relative to an actuator housing, mounting feature, etc.). According to such an embodiment, the relative linear movement of the first actuator member 12 and the second actuator member 14 may include linear movement of the second actuator member 14 in the actuation direction 20 relative to the first actuator member 12, e.g., in either the extension direction or the retraction direction. It will be appreciated that such a configuration is presented for the purpose of illustration, and that other arrangements may be equally utilized. Accordingly, the direction of linear movement may depend upon the handedness of the first threaded interface and the direction of relative rotation.

In the illustrative example embodiment of FIG. 1, the first actuator member 12 is depicted as a threaded shaft, and the second actuator member 14 is depicted, with respect to the first threaded interface 18, as a threaded bore. Consistent with such an embodiment, both of the first actuator member and the second actuator member may be substantially threaded about the respective lengths thereof (e.g., about at least a sufficient length to achieve the desired linear travel of the linear actuator). It will be appreciated that other configurations may equally be implemented. For example, the first actuator member may include a threaded shaft that is threaded about at least a portion thereof (e.g., at least a sufficient length to achieve the desired linear actuation), and the second actuator member may include a partially threaded bore. For example, the internal threads within the second actuator member may only include sufficient internal threads to allow adequate force transmission via the first threaded interface to meet the requirements of the linear actuator, e.g., without concerns of damaging the threads of the first threaded interface. For example, the internal threads may have a linear expanse equal to the diameter (“D”) of the external threads of the first actuator member—i.e., 1×D thread depth. Other thread depths may equally be implemented, e.g., 1.5×D, 2×D, etc. Consistent with some such embodiments, a shorter extent of the internal threads of the second actuator member may, e.g., facilitate manufacturing (e.g., as the manufacture of internal threads may be relatively more complicated than the manufacture of external threads), may reduce the rotational mass of the second actuator member (e.g., which may decrease inertial loads an a motor driving the second actuator, may reduce the frictional losses associated with the first threaded interface, and/or may provide additional and/or alternative benefits. In some implementations, the internal threads of the first threaded interface 18 may be integrally formed with the second actuator member. In further embodiments, the internal threads of the first threaded interface 18 may include a separate component from the second actuator member 14 (such as a nut, or other internally threaded feature) which may be coupled to the second actuator member 14 (e.g., permanently coupled and/or removably coupled). Additionally, it will be appreciated that in an embodiment in which only a portion of the interior surface of the second actuator member is provided with internal threads, at least a portion of the non-threaded portion of the second actuator member may have an internal diameter greater than the outside diameter of the external threads, e.g., to allow relative linear movement of the first actuator member and the second actuator member.

In a generally similar manner as discussed above with respect to the internal threads of the first threaded interface 18, in some embodiments, the first actuator member 12 may include external threads along a substantial extend of the first actuator member. For example, the external threads may extend along a sufficient length of the first actuator member 12 to achieve full extension and/or retraction of the linear actuator 10 (i.e., full stroke of the actuator). In some embodiments, only a portion of the first actuator member 12 may include external threads (e.g., may include a threaded portion that is shorter than the full stroke of the actuator). Consistent with some such embodiments, the internal threads of the first threaded interface 18 (e.g., which may be associated with the second actuator member 14) may be of sufficient length to achieve full stroke of the actuator 10. In a similar manner as described above with respect to the internal threads of the first threaded interface 18, in some implementations a relatively shorter extent of external threads (i.e., less than the length of the full stroke of the linear actuator) may, for example, reduce the frictional drag of the first threaded interface.

In a generally similar manner as discussed with respect to the first threaded interface 18, the second threaded interface may include an external thread associated with the second actuator member and an internal thread associated with the third actuator member. For example, as shown in FIG. 1 the second actuator member 14 may include an exterior surface that is at least partially threaded (e.g., includes external threads). The third actuator member 16 may include an inner surface (e.g., such as an internal bore) that may be at least partially threaded. As such, the external threads associated with the second actuator member 14 may engage with the internal threads of the third actuator member to form the second threaded interface 22. As generally discussed above with respect to the first threaded interface 18, in some embodiments the second actuator member 14 may include external threads along a substantial portion thereof (e.g., a length of external threads sufficient to achieve full stroke of the linear actuator). Further, in some embodiments the section actuator member 14 may include external threads along only a portion thereof (e.g. a length of external threads less than the full travel/stroke of the linear actuator). Correspondingly, in some embodiments the third actuator member 16 may include internal threads along a substantial portion thereof (e.g., a length of internal thread sufficient to achieve full stroke of the linear actuator), and/or may include internal threads along only a portion thereof (e.g., a length of internal threads less than the full stroke of the linear actuator). In some implementation, e.g., in which the internal threads of the third actuator member 16 extend a length less than the full stroke of the linear actuator, the internal threads may include a nut (or similar internally threaded arrangement or component). In some such implementations the nut may be integral with the third actuator member 16, and/or may be a separate component coupled thereto.

In a similar manner as discussed with respect to the first threaded interface, rotational actuation of the second threaded interface 22 may produce relative linear movement of the second actuator member 14 and the third actuator member 16 along the actuation direction 20 as the internal threads of the third actuator member 16 tighten or loosen on the external threads of the second actuator member 14, and/or the external threads of the second actuator member 14 tighten or loosen within the internal threads of the third actuator member 16. In a generally corresponding manner as discussed above with respect to the first threaded interface 18, rotational actuation of the second threaded interface 22 may include any change in relative rotational position of the second actuator member 14 and the third actuator member 16 with respect to one another, including, but not limited to, rotation of the second actuator member, rotation of the third actuator member, and rotation of both the second actuator member and the third actuator member (either in opposite directions, in the same direction but with one member rotating to a lesser extent, or at a slower rate, than the other member).

Further, the amount of linear movement, or travel, of the first actuator member, the second actuator member, and/or the third actuator member (and/or of the linear actuator output, which may be effected via fourth actuator member/output 24) may be based upon, at least in part, one or more of, the pitch of the first threaded interface, the pitch of the second threaded interface, the amount of rotational actuation of the first threaded interface, and the amount of rotational actuation of the second threaded interface. Consistent with various implementations, the first threaded interface and the second threaded interface may have the same thread pitch, and/or may have different thread pitches. Further, and as will be discussed in greater detail below, in various modes of operation (e.g., either controlled operation and/or operation resulting from an at least partial failure or operational restriction of one or more components of the linear actuator) both of the first threaded interface and the second threaded interface may be rotationally actuated (e.g., undergo relative rotational movement), of the same amount and/or of differing amounts, and/or only one of the first threaded interface and the second threaded interface may be rotationally actuated. Further, in various modes of operation the first threaded interface and/or the second threaded interface may be rotationally actuated by different combinations of rotational movement of the first actuator member, the second actuator member, and the third actuator member.

Consistent with some implementations, the first threaded interface 18 and the second threaded interface 22 may include opposite thread directions. For example, as generally discussed above, in an illustrative example embodiment, the first threaded interface 18 may include righthanded threads. As such, relative rotation of the second actuator member 14 in a counterclockwise direction viewed from the top of FIG. 1 (e.g., via one or both of relative rotation of the second actuator member in a counterclockwise direction and/or relative rotation of the first actuator member in the clockwise direction viewed from the top of FIG. 1) may loosen the second actuator member relative to the first actuator member and result in relative linear movement extending the linear actuator (e.g., one or more of linear movement of the second actuator member upwardly in FIG. 1 and/or linear movement of the first actuator member downwardly in FIG. 1). Further, the second threaded interface 22 may include lefthanded threads. As such, relative rotation of the second actuator member 14 in the counterclockwise direction viewed from the top of FIG. 1 (e.g., via one or both of relative rotation of the second actuator member in the counterclockwise direction and/or relative rotation of the third actuator member in the clockwise direction) may loosen the third actuator member 16 relative to the second actuator member 14, and result in linear movement extending the linear actuator (e.g., one or more of linear movement of the third actuator member upwardly in FIG. 1 and/or linear movement of the second actuator member downwardly in FIG. 1).

In the foregoing illustrative example, the linear actuator may be extended by one or more of clockwise rotation of the first actuator member, counterclockwise rotation of the second actuator member, and/or clockwise rotation of the third actuator member. Furthermore, combinations of such rotational movements of the various actuator members may increase the speed of actuation of the linear actuator and/or reduce the relative rotational actuation force required by the various actuator members. For example, as generally described above, clockwise rotation of the first actuator member along with counterclockwise rotation of the second actuator member may increase the speed at which the linear actuator is extended, as both rotations may loosen the second actuator member relative to the first actuator member. Similarly, counterclockwise rotation of the second actuator member along with clockwise rotation of the third actuator member may increase the speed at which the linear actuator is extended, as both rotations may loosen the third actuator member with respect to the second actuator member. Clockwise rotation of the first actuator member along with clockwise rotation of the third actuator member may increase the speed at which the linear actuator is extended, as the rotations may loosen the second actuator member with respect to the first actuator member, and loosen the third actuator member with respect to the second actuator member. Counterclockwise rotation of the second actuator member may both loosen the second actuator member with respect to the first actuator member and also loosen the third actuator member with respect to the second actuator member. It will be appreciated that various additional and/or alternative rotational combinations may be utilized and/or experienced, which may provide different speeds of travel of the linear actuator (in each an extension direction or a retraction direction, as the case may be), and require different rotational forces at the rotationally actuated actuator members. It will be understood that linear movement to extend or retract the linear actuator may vary depending upon the handedness of each threaded interface and the relative direction of rotation of each threaded interface. Further the “speed at which the linear actuator extends and/or retracts is dependent upon one or more of the rate or rotational actuation of each threaded interface and the pitch of each threaded interface.

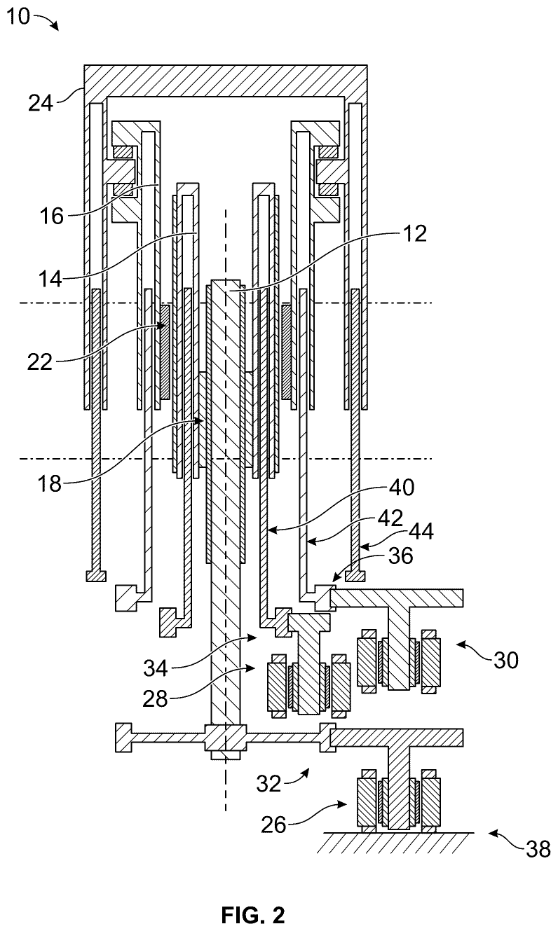

The linear actuator may further include one or more of a first rotational actuator for rotating the first actuator member, a second rotational actuator for rotating the second actuator member, and a third rotational actuator for rotating the third actuator member. For example, as generally discussed above, the first threaded interface 18 may be rotationally actuated, e.g., by relative rotation of the first actuator member 12 and the second actuator member 14. This relative rotation may be accomplished by rotating one, or both, of the first actuator member and the second actuator member. Further, the second threaded interface 22 may be rotationally actuated by relative rotation of the second actuator member 14 and the third actuator member 16. This relative rotation may be accomplished by rotating one, or both, of the second actuator member and the third actuator member. Accordingly, in an illustrative example embodiment, and with additional reference to FIG. 2, the linear actuator 10 may include a first rotational actuator 26 for rotating the first actuator member 12. The linear actuator 10 may include a second rotational actuator 28 for rotating the second actuator member 24. The linear actuator 10 may include a third rotational actuator 30 for rotating the third actuator member 16.

Consistent with some implementations, the linear actuator 10 may include an electro-mechanical actuator. According to such an embodiment, one or more of the first rotational actuator 26, the second rotational actuator 28, and the third rotational actuator 30 may include an electric motor. Any suitable electric motors may be utilized, including, but not limited to, a brushless DC motor, a brushed DC motor, a servo motor, a stepper motor, an AC electric motor, and/or any suitable combinations thereof. Other motors and/or mechanisms for rotating the respective actuator members may be utilized. Additionally, as generally shown, the respective rotational actuators may include drivetrains (e.g., drivetrains 32, 34, 36, respectively) for rotationally actuating the respective actuator members. The drivetrains may include any combination and/or configuration of gears, belts, chains, clutches, etc. for providing controllable rotational actuation of the respective actuator members.

In some implementations, the respective rotational actuators may be sized (e.g., torque output, rotational speed, etc.) such that each rotational actuation may be capable of driving the entire linear actuator 10 within a desired time frame. For example, as generally discussed above, the first actuator member 12, the second actuator member 14, and the third actuator member 16 may be rotated in concert to effectuate rotational actuation of the first threaded interface 18 and the second threaded interface 22. For example, each of the three actuator members may be rotated together (e.g., by the respective rotational actuators). Additionally, as generally described, in various operational modes different ones of the actuator members may be rotated in combination, or individually, to effectuate rotational actuation of one, or both, of the first and second threaded interfaces. In some embodiments, rotation of a single actuator member may effectuate full linear travel of the linear actuator 10. Accordingly, in some embodiments the rotational actuators may be sized such that a single rotational actuator can effectuate fully linear travel of the linear actuator in a desired and/or predefined time period.

With continued reference also to FIG. 2, the linear actuator 10 may further include one or more of a first carrier 38 mounting the first rotational actuator 26, a second carrier 40 mounting the second rotational actuator 28, and a third carrier 42 mounting the third rotational actuator 30. Consistent with the illustrative example embodiment shown in FIGS. 1-2, the respective carriers may one or more of mount a respective rotational actuator to an actuator housing/mounting feature and/or couple the rotational actuator for rotating a respective actuator member and permit linear movement of the respective actuator member. For example, as shown in FIGS. 1 and 2, the first carrier 38 may support the first rotational actuator 26 for rotating the first actuator member 12. Further, the second carrier 40 may mount the second rotational actuator 28 for rotating the second actuator member 14 and enabling the second actuator member to translate along the actuation direction. For example, the second carrier may include one or more longitudinal members (e.g., longitudinal members 40A, 40B) extending in the actuation direction 20, which may be received in cooperating slots (e.g., slots 14A, 14B) in the second actuation member. Accordingly, when the second carrier 40 is rotationally driven by the second rotational actuator 28, the engagement of the longitudinal members 40A, 40B in the respective slots 14A, 14B may cause the second actuator member 14 to rotate. Further, as the longitudinal members 40A, 40B may be slidingly received in the respective slots 14A, 14B, the second actuator member may be capable of linear movement along the actuation direction. The carrier and the actuator member may include one or more longitudinal members and cooperating slots. Further, the longitudinal members and slots may have any desired configuration that may allow rotational actuation of the actuator member and sliding movement of the actuator member along the direction of actuation, including, but not limited to, square cross-section, rectangular cross-section, arcuate cross-section, round cross-section, oval cross-section, etc. Additionally, the number of longitudinal member and cooperating slots, or pockets, may vary according to design criteria.

As shown in the illustrated example embodiment, the third carrier 42 and third actuator member 16 may include similar arrangement as discussed with respect to the second carrier 40 and the second actuator member 14. Accordingly, the third actuator member 16 may be rotationally actuated by the third rotational actuator 30 via the third carrier 42 while still allowing the third actuator member 14 to translate along the actuation direction. In some embodiments, the linear actuator may include an actuator output 24. The actuator output 24 may, for example, be coupled with the third actuator member 14 for linear movement along the actuation direction 20, while being rotationally isolated from the third actuator member 16 (e.g., via a rotational coupling, such as a bearing, bushing, sliding connection, etc.) such that linear movement of the third actuator member 16 may produce a corresponding linear movement of the actuator output 24. However, the rotational isolation between the third actuator member 16 and the actuator output 24 may be such that rotational movement of the third actuator member 16 does not impart rotational movement of the actuator output 24. In one such example, the actuator output may resist rotational movement via a fourth carrier 44. In the illustrated embodiment, the fourth carrier 44 may have a generally similar configuration as the second carrier and the third carrier, i.e., one or more longitudinal members slidingly received within one or more slots or pockets. However, other implementations may equally be utilized (e.g., a splined or keyed connection between the actuator output 24 and an actuator housing, etc.).

As generally shown in the illustrative example embodiment of FIGS. 1-2, the first carrier, the second carrier, and the third carrier may be mutually telescoping along the actuation direction. That is, for example, the second carrier 40 may allow for telescoping movement of the second actuator member 14 with respect to the first actuator member 12 and/or the first carrier 38. Similarly, the third carrier 42 may allow for telescoping movement of the third actuator member 16 with respect to the second actuator member 14 and/or the second carrier 40. Consistent with the example embodiment shown in FIGS. 1-2 the rotational actuators may generally remain stationary in at least the actuation direction, and the carriers may allow for the extension and retraction of the actuator (e.g., one or more of the first actuator member, the second actuator member, the third actuator member, and the actuator output).

Consistent with the foregoing description, the first threaded interface and the second threaded interface may each provide a respective actuator stage. For example, the first threaded interface may provide for the extension and/or retraction of the linear actuator. Similarly, the second threaded interface may provide for the extension and/or retraction of the linear actuator. Accordingly, the illustrated example embodiment may include dual redundant actuator in that if one of the threaded interfaces fails (e.g., relative rotational movement of a threaded interface is impeded) and/or one or more rotational actuators fail (the number of permitted failed rotational actuators depends upon the actuator members being driven by the failed rotational actuators, as discussed in greater detail below), the remaining threaded interface and/or rotational actuator(s) can still achieve full travel of the linear actuator. Additional stages having a similar configuration may be implemented. For example, a third threaded interface may be provided between the third actuator member and a fourth actuator member (e.g., including external threads on the third actuator member and internal threads on a fourth actuator member). Additional actuator stages may additionally include alternating thread directions between the various actuator stages (e.g., between the first threaded interface, the second threaded interface, the third threaded interface, etc.).

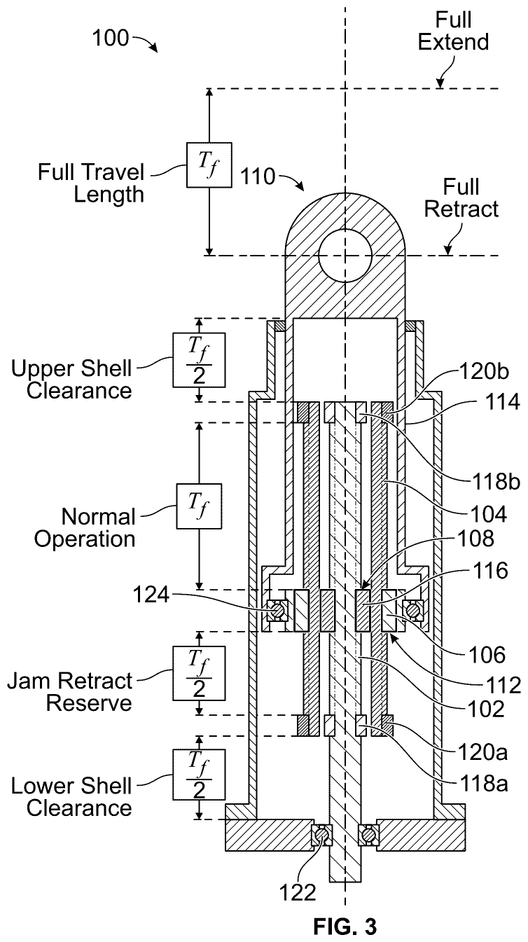

With reference also to FIG. 3, another illustrative example embodiment of a linear actuator 100 is schematically depicted. In some implementations, linear actuator 100 may have a generally similar configuration as linear actuator 10. For example, linear actuator 100 may generally include a first actuator member 102 (e.g., “pink”), a second actuator member 104 (e.g., “orange”), and a third actuator member 106 (e.g., “green”). The linear actuator 100 may additionally include a first threaded interface 108 (e.g., “pink-orange”) that may be provided between the first actuator member 102 and the second actuator member 104. The first threaded interface 108 may be configured to produce relative linear movement of the first actuator member 102 and the second actuator member 104 along an actuation direction 110 during rotational actuation of the first threaded interface 108. A second threaded interface 112 (e.g., “orange-green”) may be provided between the second actuator member 104 and the third actuator member 106. The second threaded interface 112 may be configured to produce relative linear movement of the second actuator member 104 and the third actuator member 106 along the actuation direction 110 during rotational actuation of the second threaded interface 112. Further, in some implementations, an actuator output 114 may be coupled with the third actuator member 116 to provide a relative linear movement output for the actuator 100. As such, the actuator output may include features for coupling with components to be actuated via the linear actuator 100, and/or one or more additional components for effectuating actuation of items using the linear actuator.

Consistent with the example embodiment of FIG. 3, the first threaded interface 108 may include an external thread (not depicted in detail for clarity of illustration) associated with the first actuator member 102, as generally discussed with regard to previous embodiments. Further, the first threaded interface 108 may include an internal thread (not depicted in detail for clarity of illustration) associated with the second actuator member 104. Consistent with the illustrated example embodiment, the internal thread associated with the second actuator member 104 may include a nut 116 that may threadably engage the external threads of the first actuator member 102. As generally discussed above, the use of the nut 116 may simplify manufacture, reduce inertial associated with the second actuator member and/or the first threaded interface, reduce frictional effects associated with the first threaded interface, etc. In one particular illustrative example embodiment, the first actuator member may include a threaded shaft, and the second actuator member may include a shell, or generally tubular member, surrounding the threaded shaft of the first actuator member. The nut may be integrated with, and/or coupled to, the second actuator member. In a particular embodiment consistent with the foregoing, the first actuator member may be threaded along a sufficient length thereof to effectuate full extension/retraction of the linear actuator.

In an example embodiment, the second threaded interface 112 may include an external thread (not depicted in detail for clarity of illustration) associated with the second actuator member 104 and an internal thread (not depicted in detail for clarity of illustration) associated with the third actuator member 106. In one such embodiment, the third actuator member 106 may include a nut. Similar with the first threaded interface, the use of a nut may simplify manufacture, reduce inertia associated with the third actuator member, reduce frictional effects associated with the second threaded interface, etc. In a particular embodiment consistent with the foregoing, the second actuator member may be threaded along a sufficient length thereof to effectuate full extension/retraction of the linear actuator. Consistent with an example embodiment, the threads of the second threaded interface may be of the opposite handedness as the threads of the first threaded interface, as discussed previously.

Consistent with the present disclosure, the threads utilized for the first threaded interface and/or the second threaded interface may include any suitable threaded features. For example, the threaded interfaces may include V-threads, square threads, Acme threads, buttress threads, ball screws, roller screws, etc. The first threaded interface and the second threaded interface may include the same type of threaded interface, and/or may include different types of threads.

According to some embodiments, the first threaded interface and the second threaded interface may be coaxial. For example, in the example embodiment shown in FIG. 3, the second actuator member 104 may generally include a shell at least partially surrounding the first actuator member 102, and the third actuator member 106 may at least partially surround the second actuator member 104. In one such embodiment, the first actuator member, the second actuator member, and the third actuator member may be coaxial with one another. Such an arrangement may also place the first threaded interface and the second threaded interface coaxial with one another.

As generally depicted in FIG. 3, an actuator consistent with some embodiments of the present disclosure may include a variety of additional features. For example, as shown the first actuator member 102 may include end stops 118a, 118b to limit the extent of travel of the second actuator member 104 with relative to the first actuator member 102. Similarly, the second actuator member 104 may include end stops 120a, 120b to limit the extent of travel of the third actuator member 106 relative to the second actuator member 104. Additionally, in some embodiments thrust bearings 122 may be associated with the first actuator member 102 (e.g., between the first actuator member and a housing and/or other structural member of the linear actuator). Similarly, thrust bearings 124 may be provided between the third actuator member 106 and the actuator output 114, e.g., to rotationally isolate the actuator output from the third actuator member 106, while still allowing linear movement and/or forces to be transmitted therebetween. The actuator may additionally include various other components, such as seals, structural members or housings, mounting features, etc., which may be included and/or take a variety of forms depending upon design criteria and/or intended applications for the linear actuator.

As generally discussed above, in one example embodiment consistent with the present disclose one or more of the first threaded interface and the second threaded interface may include a ball screw interface. In general, a ball screw thread may include corresponding male and female helical raceways having ball bearings therebetween. Further, at least one of the helical raceways may include a recirculation path that may allow ball bearings to travel from one end of a helical raceway to the other end of the helical raceway. For example, in an embodiment the first actuator member may include a threaded shaft that may define a first helical raceway (e.g., an external helical raceway), and a portion of the second actuator member may provide a second helical raceway (e.g., an internal helical nut raceway). In an example implementation a recirculation pathway may be provided, e.g., between a first end of the second helical raceway and a second end of the second helical raceway so that ball bearing may exit the second helical raceway at one end, and reenter the helical raceway other the other end.

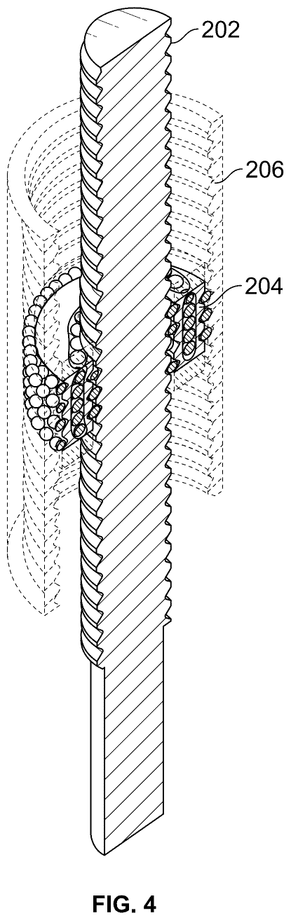

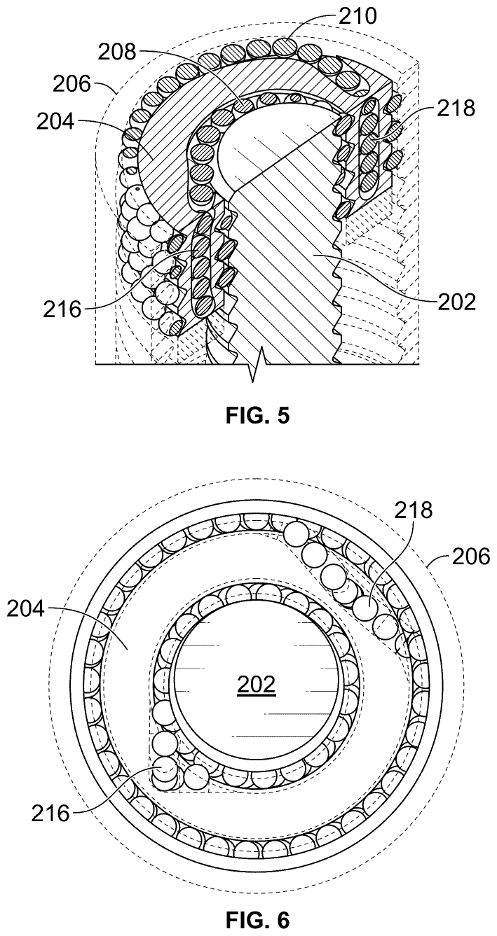

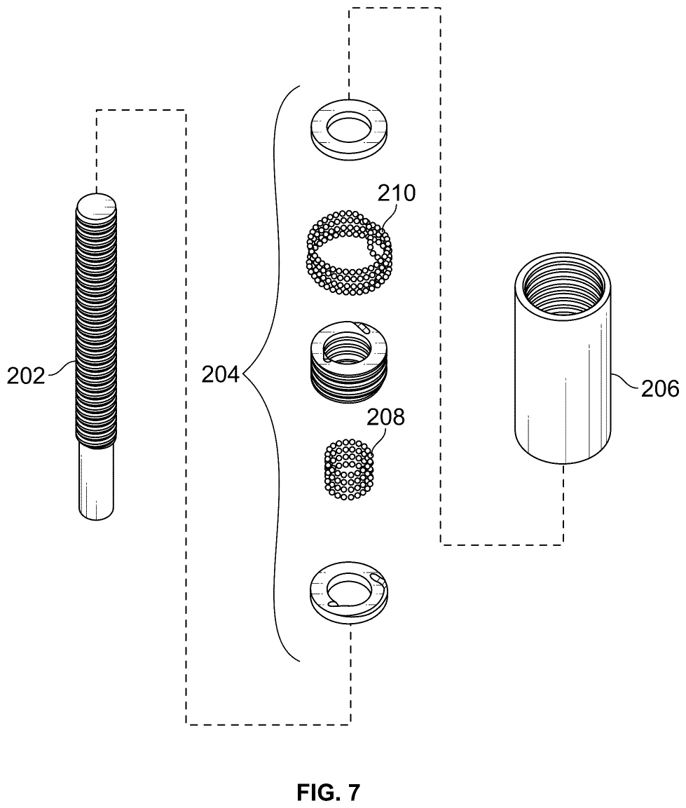

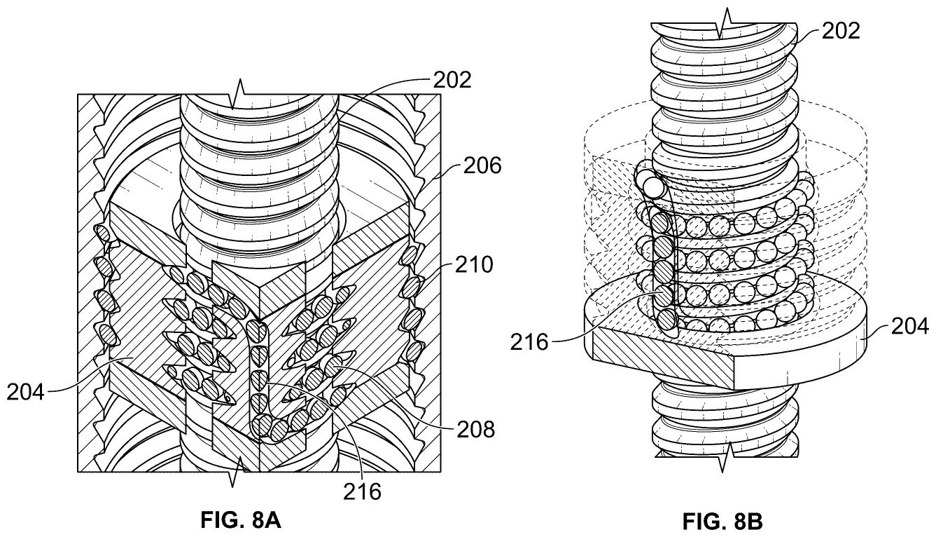

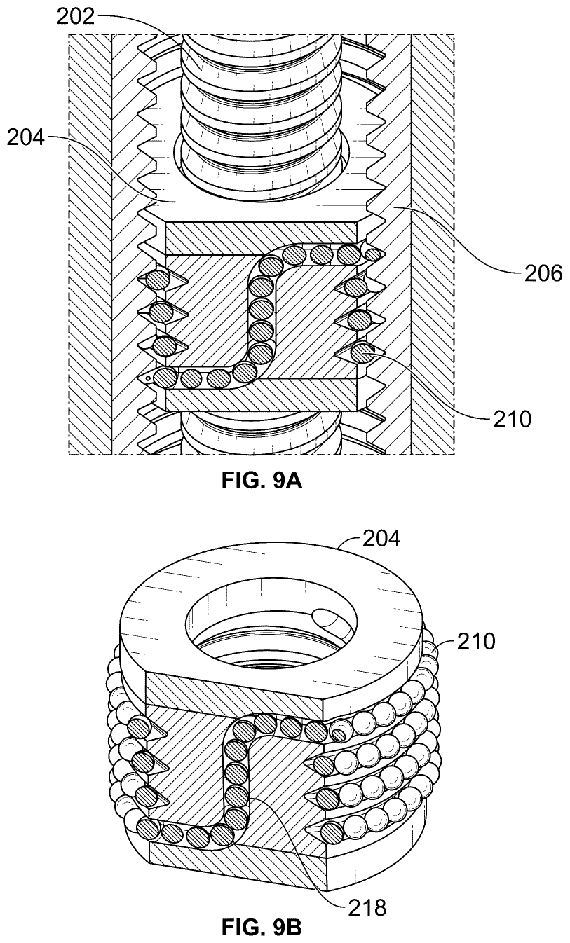

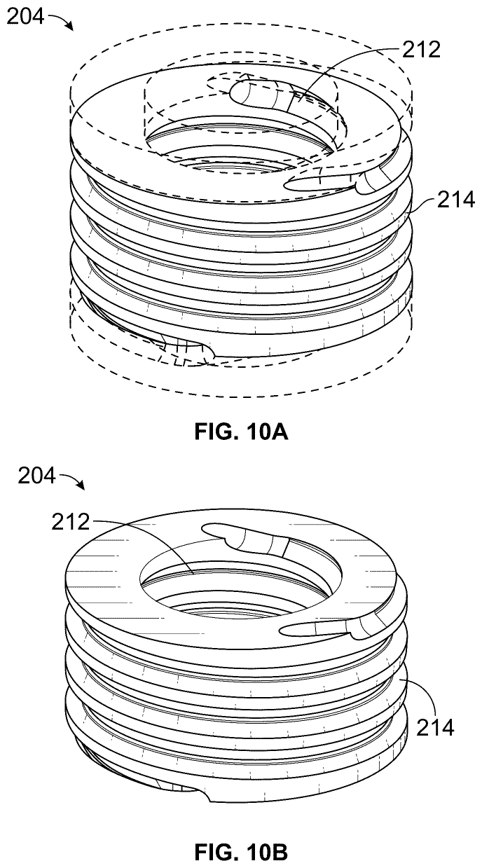

With additional reference also to FIGS. 4-12, according to one particular example embodiment, the first threaded interface and the second threaded interface may include a compound coaxial ball screw associated with the second actuator member. Consistent with the illustrated example embodiment, the compound coaxial ball screw may be implemented in connection with a first actuator member 202 (e.g., “pink”) that may include an at least partially threaded shaft, and a third actuator member 206 (e.g., “green”) that may include an at least partially threaded bore (e.g., inside diameter of a tube or cylinder, or other internally threaded bore). The compound coaxial ball nut 204 (e.g., “orange”) may be implemented as the second actuator member and/or may be integrated with and/or coupled to the second actuator member. Consistent with the present disclosure, the compound coaxial ball screw may include two independent ball circuits. For example, as shown in the illustrated example embodiment, the compound coaxial ball nut 204 may include an inside ball circuit 208 (e.g., “orange circuit”) and an independent outside ball circuit 210 (e.g., “green circuit”).

As shown, the inside ball circuit 208 may form part of the first threaded interface, in which the ball bearings may interact between an inside raceway 212 of the ball nut 204 and the threaded portion of the first actuator member 202. Similarly, the outside ball circuit 210 may form part of the second threaded interface, in which the ball bearings may interact between an outside raceway 214 and the threaded portion of the third actuator member. In some example embodiments, the ball nut may generally include a hollow cylinder with ball screw threads formed on both the inside diameter and the outside diameters (e.g., forming the inside raceway and outside raceway, respectively). In some implementations, the compound coaxial ball screw arrangement may provide a ball screw having a reduced radial footprint and may allow multiple rotating inputs to sum to an axial translation.

As generally discussed above, in an example embodiment, the compound coaxial ball screw may include two independent ball circuits (e.g., the inside ball circuit 208 and the outside ball circuit 210 in the illustrated example embodiment). As noted, the inside ball circuit may roll between the threads on the inside diameter of the ball nut (e.g., the inside raceway 212) and the threads on the outside diameter of the first actuator member. Additionally, the outside ball circuit may roll between the threads on the outside diameter of the ball nut (e.g., the outside raceway 214) and the threads on the inside diameter of the third actuator member. Each of the ball circuits may include an independent return path (e.g., inside ball circuit return path 216, and outside ball circuit return path 218), which may be formed as independent channels through the ball nut. As both ball circuit return paths travel within the same ball nut body, the radial footprint may be smaller than may be achieved using conventional ball screw arrangements. As shown, the two ball circuit return paths may be offset from one another, thereby providing sufficient clearance for each respective return path.

Consistent with the present disclosure, rotation of the first actuator member (e.g., which may include an threaded shaft, in some implementations), the ball nut (e.g., the which may include, be integrated with, and/or coupled to the second actuator member), or the third actuator member may accomplish translation (e.g., linear movement). The resulting translation may be a function of the three rotation angles (e.g., the rotation angle of the first actuator member, the rotation angle of the ball nut, and the rotation angle of the third actuator member) and the thread pitch at the first threaded interface and the second threaded interface (which may be the same as one another and/or may be different than one another).

Consistent with various embodiments, the mechanism for recirculation may have different implementations. However, generally the rolling elements (e.g., ball bearings) may migrate and exit one end of the threaded interface and may be returned to the opposite end. This mechanism may be true for CCW and CW threads. Advantageously, the recirculation path for each ball circuit may avoid the channels in the spiral threaded path and may use functional minimum wall thicknesses to separate the paths. Structural wall thickness may also contribute to radial footprint of the compound coaxial ball screw. In some embodiments consistent with the present disclosure, recirculating the inverted ball nut through the inner ball nut body may take advantage of unused volume in a conventional ball nut body. Combining the two recirculation paths in the same ball nut body may allow the radial dimension stack to be reduced. As rotor inertia may scale with radius squared, the reduction in radius may be beneficial in applications such as when driven by a servo motor. Additionally, integrating an inside ball circuit and an outside ball circuit in the same ball nut may reduce the part count and fastener requirements for the compound coaxial ball screw. Further, the compound coaxial ball screw may simplify the method for applying torque to the compound nut with an axial interface.

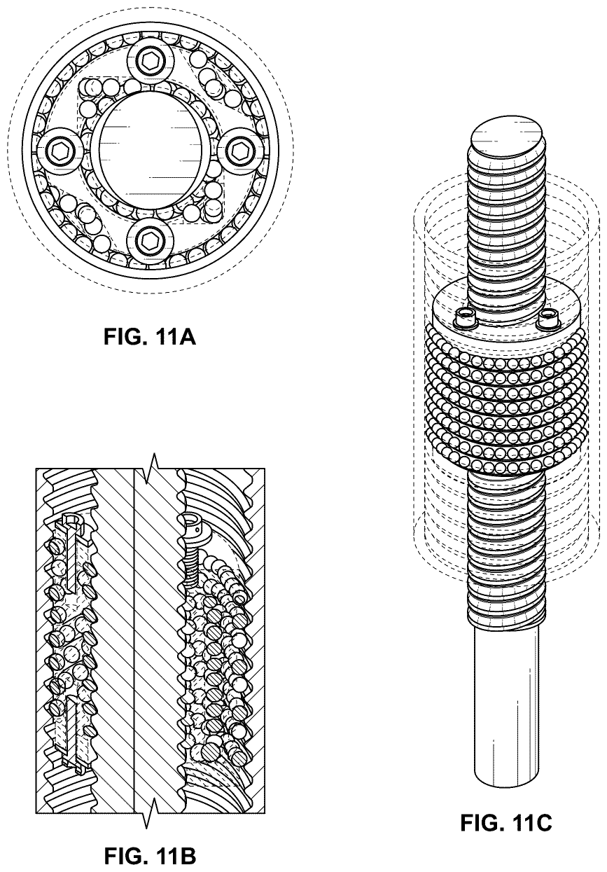

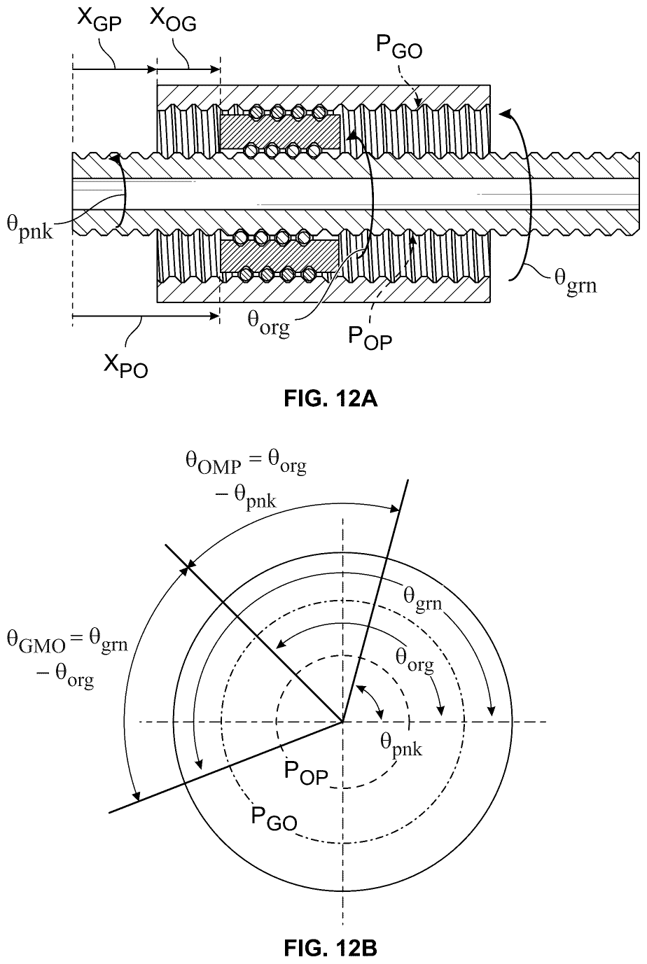

Consistent with some implementations, the compound coaxial ball screw may be utilized with multiple ball circuits (e.g., more than one ball circuit associated with the inside diameter of the ball nut and/or more than one ball circuit associated with the outside diameter of the ball nut). In some such implementations the use of redundant ball circuits may protect against catastrophic evacuation. Referring to FIGS. 11A-11C, consistent with some such embodiments, duplicate return paths and additional fasteners may be utilized to balance the use of volume. As shown, multiple ball circuits may be implemented in connection with multi-start threads (e.g., associated with the first actuator member and/or the third actuator member). Further, the use of multiple ball circuits may increase the minimum pitch for a given ball circuit (e.g., as multiple adjacent ball circuits are accommodated).

With reference also to FIGS. 12A-12B, the general operation of an example embodiment of a compound coaxial ball screw consistent with the present disclosure is generally set out. Consistent with the illustrated embodiment, in which “pink” may reference a first actuator member (e.g., which may include an externa thread, such as a threaded shaft), “orange” may represent a second actuator member (e.g., which may include and/or be coupled with the ball nut), and “green” may reference a third actuator member (e.g., which may include an internal thread, such as a threaded bore or internally threaded tube/cylinder), the operation of the compound coaxial ball screw may be given by:

$${θ}_{pnk} = Pink Rotation Angle$$

$${θ}_{org} = Orange Rotation Angle$$

$${θ}_{grn} = Green Rotation Angle$$

$${θ}_{OMP} = Orange Minus Pink Angle$$

$${θ}_{GMO} = Green Minus Orange Angle$$

$$Pitch := \frac{Travel}{Rotation} = \frac{X}{θ}$$

Note: per the above conventions, a (+)θ and a (−)Pitch will create a (+)Travel to the right.
   This implies that a Left-Handed (CCW) thread is a (+) pitch value and a Right-Handed (CW) thread is a (−) pitch value

$${P}_{OP} = Thread Pitch between Pink and Orange$$

$${P}_{GO} = Thread Pitch between Orange and Green$$

$${X}_{OP} = Travel between Orange and Pink$$

$${X}_{GO} = Travel between Green and Orange$$

$${X}_{GP} = Travel between Pink and Green$$

Given the foregoing, the relationships between angular movement and linear travel may be:

### Relations:

$${X}_{OP} ( {θ}_{pnk} , {θ}_{org} ) = ( {θ}_{org} - {θ}_{pnk} ) * {P}_{OP} = {θ}_{OMP} * {P}_{OP}$$

$${X}_{GO} ( {θ}_{org} , {θ}_{grn} ) = ( {θ}_{grn} - {θ}_{org} ) * {P}_{GO} = {θ}_{GMO} * {P}_{GO}$$

$${X}_{GP} ( {θ}_{OMP} , {θ}_{GMO} ) = {X}_{GO} + {X}_{OP} = {P}_{OP} * {θ}_{OMP} + {P}_{GO} * {θ}_{GMO}$$

$${X}_{GP} ( {θ}_{pnk} , {θ}_{org} , {θ}_{grn} ) = {P}_{OP} * ( {θ}_{org} - {θ}_{pnk} ) + {P}_{GO} * ( {θ}_{grn} - {θ}_{org} )$$

$$\\ \begin{matrix}{X}_{GP} ( {θ}_{pnk} , {θ}_{org} , {θ}_{grn} ) = - {θ}_{pnk} * {P}_{OP} + {θ}_{org} * ( {P}_{OP} - {P}_{GO} ) + {θ}_{grn} * {P}_{GO}\end{matrix}$$

The above equation may be true for any combination of polarity and magnitude for P_{OP} and P_{GO}. Turning Orange effectively moves Green from Pink like a screw with a pitch

$$P = {P}_{OP} - {P}_{GO}$$

In one illustrative example, if the threads are the same polarity and equal, then:

$$P = {P}_{OP} = {P}_{GO} and {X}_{GP} = P * ( {θ}_{grn} - {θ}_{pnk} )$$

In this example, X_{GP} may not be depending on θ_{org} (the orange nut can be at any position for a given X_{GP}). Equations for X_{GO} and X_{OP} may remain valid, and the orange nut position may still be defined. Also, θ_{org} will only effect the orange nut position but not the green extension. θ_{org} may only affect X_{OP} and X_{GO} and X_{GP}=X_{OP}+X_{GO} may remain true. For example, if pink is anchored and the rotation of pink and green is locked, turning orange (e.g., the ball nut) results in orange travelling at 1× pitch, while green does not travel.

In a further illustrative example, if the threads are opposite in polarity and equal, then:

$$P = {P}_{OP} = - {P}_{GO} and {X}_{GP} = P * ( - {θ}_{pnk} + 2 {θ}_{org} - {θ}_{grn} )$$

In this example, rotating orange functions like an opposite polarity, 2× pitch screw for extending green from pink. For example, if pink is anchored and the rotation of pink and green are locked, turning orange results in orange travelling 1× pitch, and green travelling 2× pitch.

Consistent with the foregoing, multiple uses may be possible by varying the polarity and magnitude of P_{GO} and P_{OP}. For example, for:

$${P}_{OP} = + 6 \frac{mm}{rev} and {P}_{GO} = + 5 \frac{mm}{rev}$$

If pink is anchored, and the rotation of green and pink are locked, turning orange +1 rev results in green moving +1 mm and orange moving +6 mm. This may represent a ball nut with a very fine pitch with large ball bearings.

In another example, in which:

$${P}_{OP} = + 5 \frac{mm}{rev} and {P}_{GO} = - 5 \frac{mm}{rev}$$

If pink is anchored and the rotation of green and pick is locked, turning orange +1 rev results in green moving +10 mm and orange moving +5 mm. This may represent a ball screw arrangement that may provide for very compact telescoping.

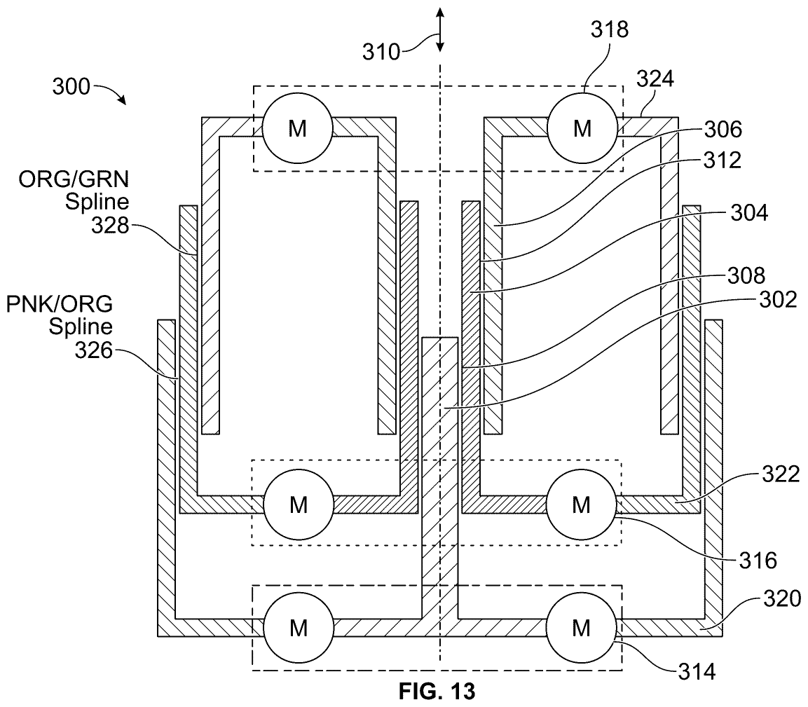

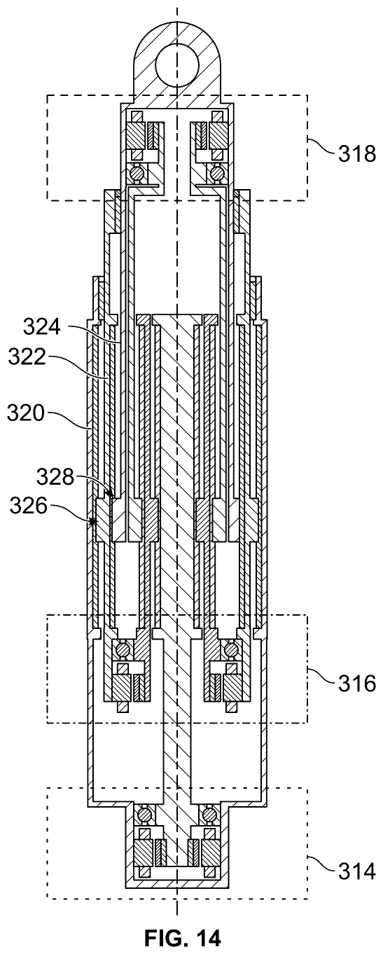

As generally discussed above, the linear actuator may include rotational actuators for respectively rotating the first actuator member, the second actuator member, and the third actuator member. For example, and with additional reference to FIGS. 13-14, in an illustrative example embodiment consistent with the present disclosure, a linear actuator 300 may generally include a first actuator member 302, a second actuator member 304, and a third actuator member 306. As generally described above, the linear actuator 300 may include a first threaded interface 308 between the first actuator member 302 and the second actuator member 304 configured to produce relative linear movement of the first actuator member and the second actuator member along an actuation direction 310. The linear actuator 300 may further include a second threaded interface 312 between the second actuator member 304 and the third actuator member 306 configured to produce relative linear movement of the second actuator member 304 and the third actuator member 306 along the actuation direction. The linear actuator may further include a first rotational actuator 314 for rotating the first actuator member 302, a second rotational actuator 316 for rotating the second actuator member 304, and a third rotational actuator 318 for rotating the third actuator member 306. The rotational actuators 314, 316, 318 may include any suitable rotational actuators, including but not limited to, brushless DC motors, brushed DC motors, AC motors, servo motors, stepper motors, etc. Additionally, the various rotational actuators may include the same type of rotational actuator, or may include different types of rotational actuators.

Continuing with the illustrative example embodiment, the linear actuator 300 may further include a first carrier 320 mounting the first rotational actuator 314, a second carrier 322 mounting the second rotational actuator 316, and a third carrier 324 mounting the third rotational actuator 318. In one embodiment consistent with the present disclosure, and as generally shown in FIG. 14, the rotor of rotational actuator 314 may be coupled with the first actuator member 302, and the stator of rotational actuator 314 may be coupled with the first carrier 320 such that the first actuator member 320 may be rotated relative to the carrier 320. Similarly, the rotor of the second rotational actuator 316 may be coupled with the second actuator member 304, and the stator of the second rotational actuator 316 may be coupled with the second carrier 322 such that the second actuator member 304 may be rotated relative to the second carrier 322. Further, the rotor of the third rotational actuator 318 may be coupled with the third actuator member 306, and the stator of the third rotational actuator 318 may be coupled with the third carrier 324 such that the third actuator member 306 may be rotated relative to the third carrier 324.

In some implementations, the first carrier 320, the second carrier 322, and the third carrier 324 may be mutually telescoping along the actuation direction. For example, in the illustrated embodiment, the first carrier 320, the second carrier 322, and the third carrier 324 may be nested with one another such that the first carrier 320 and the second carrier 322 may be slidingly moveable relative to one another. Similarly, the second carrier 322 and the third carrier 324 may be slidingly moveable relative to one another. It will be appreciated that the carriers may be implemented in a variety of configurations to achieve the mutually telescoping movement. For example, the carriers may each include tubular members, and/or shells, that may be sized to allow nesting and sliding movement, as described above. Such tubular members may include any suitable cross-sectional shape, including, but not limited to, circular, oval, square, rectangular, as well as any other suitable continuous, non-continuous, uniform and/or non-uniform shape. Additionally, it will be appreciated that the carriers could have a U-shape or an L-shape and may be mutually telescoping only at discrete points of interaction. Various additional and/or alternative configurations may be equally utilized.

In some implementations, the first carrier may be rotationally constrained relative to the second carrier. Further, in some implementations, the second carrier may be rotationally constrained relative to the third carrier. For example, in the illustrated examples of FIGS. 13-14, in which the first carrier 320, second carrier 322, and third carrier 324 may be mutually telescoping, the first carrier 320 and the second carrier 322 may be configured such that the first carrier 320 and the second carrier 322 are not rotatable relative to one another. Further, the second carrier 322 and the third carrier 324 may be configured such that the second carrier 322 and the third carrier 324 are not rotatable relative to one another. It will be appreciated that such rotational constraint may be achieved using a variety of configurations. For example, in an implementation in which the carriers include tubes and/or shells, the cross-sectional shape of the carriers may be such that the carriers may be rotationally constrained, e.g., by having a non-circular cross-section. Further, one or more of the carriers may include features for rotationally constraining the sets of carriers with respect to one another. For example, the carriers may include cooperating keyed features, such as grooves/slots and protrusions, etc. Consistent with one particular embodiment, the first carrier 320 and the second carrier 322 may include cooperating splines 326. For example, the first carrier 320 may include internal splines and the second carrier 322 may include external splines, or other arrangements depending on the configuration of the carriers. Similarly, the second carrier 322 and the third carrier 324 may also include cooperating splines 328. For example, the second carrier 322 may include internal splines and the third carrier 324 may include external splines. Accordingly, the carriers may be mutually telescoping and may also be rotationally constrained. Further, in some implementations the first carrier 320 may be rotationally constrained relative to, e.g., an actuator housing or feature to which the actuator is mounted. As such, the respective rotational actuator may rotate the respective actuator members, and may allow relative linear movement of the actuator members along the actuator direction.

Consistent with the present disclosure, in some embodiments a linear actuator may be provided in with any single jammed component will not inhibit the actuator's travel range. Further, motors utilized for rotationally actuating the components of the linear actuator may be sized so that minimum performance of the linear actuator may still met in the event of any single jam. For example, the motors may be sized such that any single motor may achieve full travel/movement of the actuator output within a defined performance envelope (e.g., time for full travel and force generated by the linear actuator). In some implementations, the linear actuator may be optimized for minimal axial length and low component count. Consistent with some illustrative example embodiments, the linear actuator may generally include three concentric shells telescoping against each other on two threads. Further consistent with some embodiments herein, the linear actuator may include traveling motors (e.g., at least some of the motors may be movable along the direction of actuator travel) and therefore may only require two anti-rotation splines. Consistent with some embodiments, the possible failure modes of the linear actuator may make it desirable to include extra travel thread and shell clearance lengths of the various actuator members, e.g., to allow full travel of the actuator when operating in a partial failure mode of operation.

In some embodiments, normal operation of the linear actuator may include an “Active-Active-Active” mode of operation, in which all motors may rotationally actuate the respective actuator member, which may provide rapid detection of a failure and reduces individual motor heating. Additionally, the “Active-Active-Active” mode of operation may reduce excess thread travel and shell clearance requirements from 4× full-travel to 2.5× full travel—for example, 6 inch stroke in Active-Passive-Passive (e.g., one motor operational, two motors non-operational) may require 24 inch minimum axial length. By comparison, an Active-Active-Active operation mode may only need 15 inches (e.g., as a theoretical minimum).

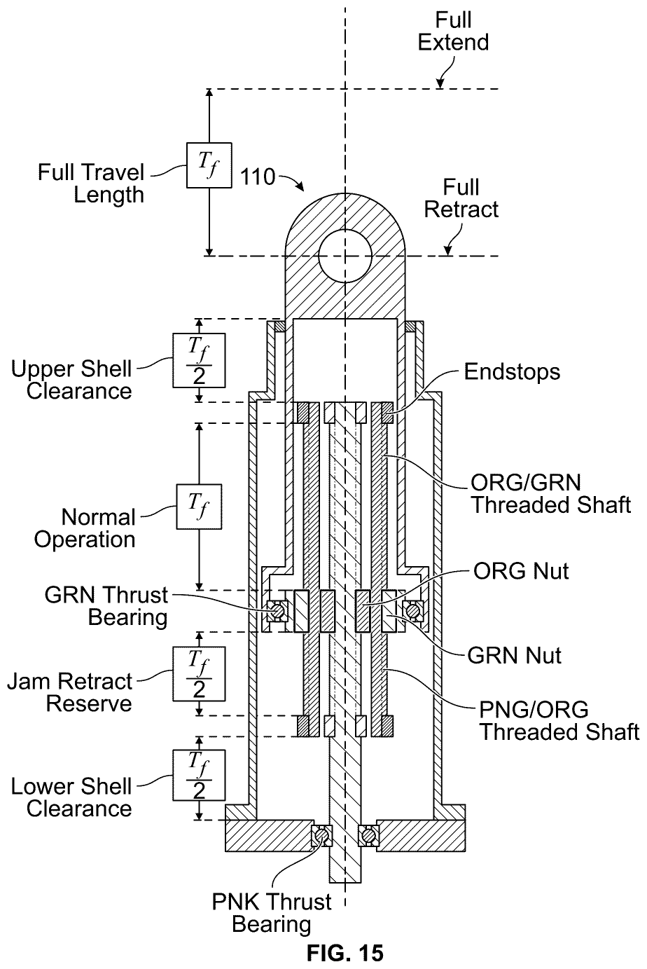

As generally discussed above, some embodiments of a linear actuator consistent with the present disclosure may include three rotational actuators (e.g., motors) driving two threaded interfaces between three actuator members. Referring also to FIG. 15, during normal operation the actuator may travel on two threads and sum to a final output position. However, during a failure state, such as a jammed threaded interface, loss of rotational actuation of one or more actuator member, etc., it may still be desirable to be able to achieve full travel of the actuator (“T_{f}”). Accordingly, in some embodiments, a linear actuator consistent with the present disclosure may include two threaded interfaces (e.g., also referred to as “nuts,” referencing the internally threaded aspect of the threaded interface) that can travel past each other on different shells. During normal operation, the actuator may travel on both threaded interfaces equally. However, excess thread lengths and clearances may be provided to allow operation of the actuator during a failure state, e.g., in which the actuator may only travel on one nut. As shown in an example embodiment of FIG. 15, a collapsed length of the actuator in a fully retracted state may be reduced buy starting the orange and green nuts (e.g., the first and second threaded interfaces) coplanar on respect shells, which may allow the orange and green nuts to travel past each other. Fault cases of the linear actuator may require excess thread lengths and clearances to permit fully travel of the linear actuator. For example, a lower shell clearance of ½ T_{f} may be provided between the bottom of the second “orange” actuator member and the base of the actuator. Similarly, a reserve thread length of ½ T_{f} may be provided between the bottom of the orange nut and the end of travel on the first “pink” actuator member. Further, an upper shell clearance of ½ T_{f} may be provided between the ends of the three actuator members and the inside end of the actuator output shell.

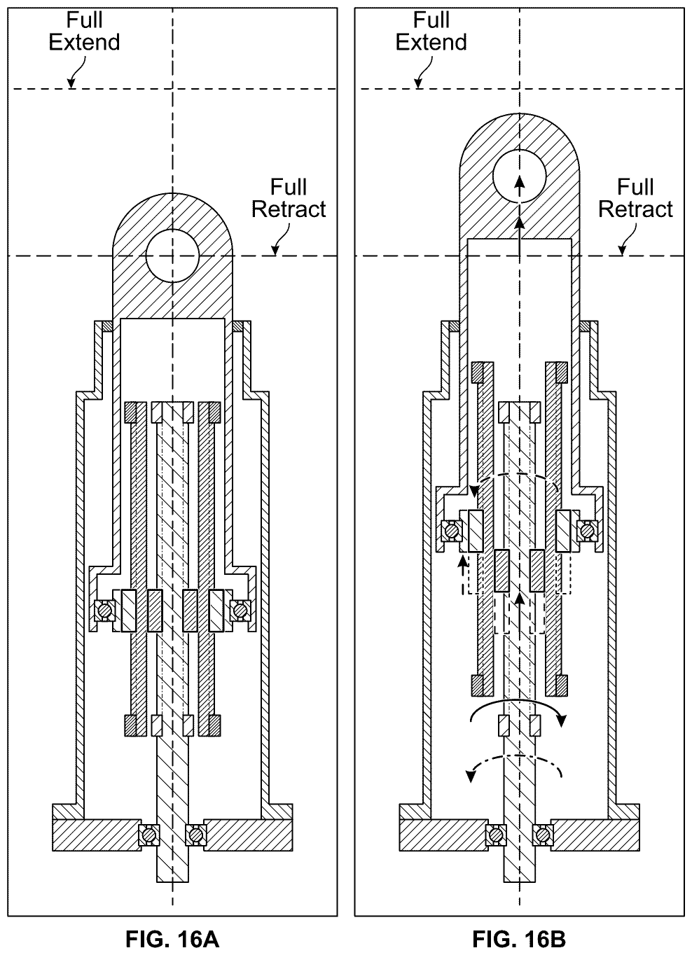

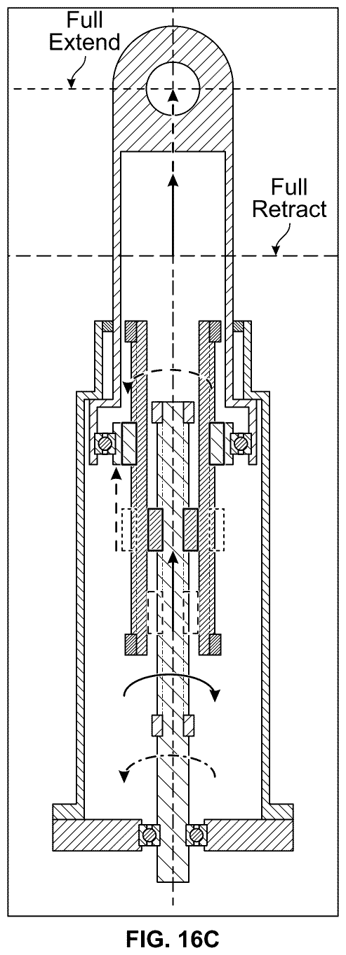

Referring to FIG. 16A-16C, an example embodiment of normal operation of an actuator consistent with the present disclosure is depicted. During normal operation, also referred to as “Active-Active-Active,” all three motors are active and turning the Pink Shaft, Orange Shell (exterior threaded shaft and interior threaded nut), and Green Nut. In some embodiments, this Active-Active-Active state may provide health monitoring of backup systems. Normal operation of the linear actuator may include 50% of travel on PNK/ORG thread, 50% of travel on ORG/GRN thread, and may provide power sharing among 3 motors. However, as discussed in greater detail below, in some embodiments, each motor may be provided to meet minimum force and slew requirements to operate the actuator alone (e.g., without power sharing with the remaining two motors).

As generally discussed above, in some embodiments the linear actuator may include two threaded interfaces, two spline interfaces (e.g., rotational constraint between the first actuator member and the second actuator member and between the second actuator member and the third actuator member). This configuration may allow each threaded interface (e.g., orange nut and green nut) to move together with the respective motor and carrier. As such, a jammed thread may have the same impact as a jammed spline. Even in the event of any one thread or spline jam/failure the actuator may still be able to achieve full travel. Further, any one jammed/failed motor may still allow two motors to move, with two threads and two splines still active. Accordingly, the linear actuator may achieve desired travel by either turning a thread or turning a nut. For example, the PNK/ORG Threaded (e.g., the first threaded interface) can be turned by either (or both) of the Pink Motor or the Orange Motor. Similarly, the ORG/GRN Thread (e.g., the second threaded interface) can be turned by either Orange Motor or Green Motor. The splines may prevent rotation of telescoping shells (motor stator anchored to corresponding housing color).

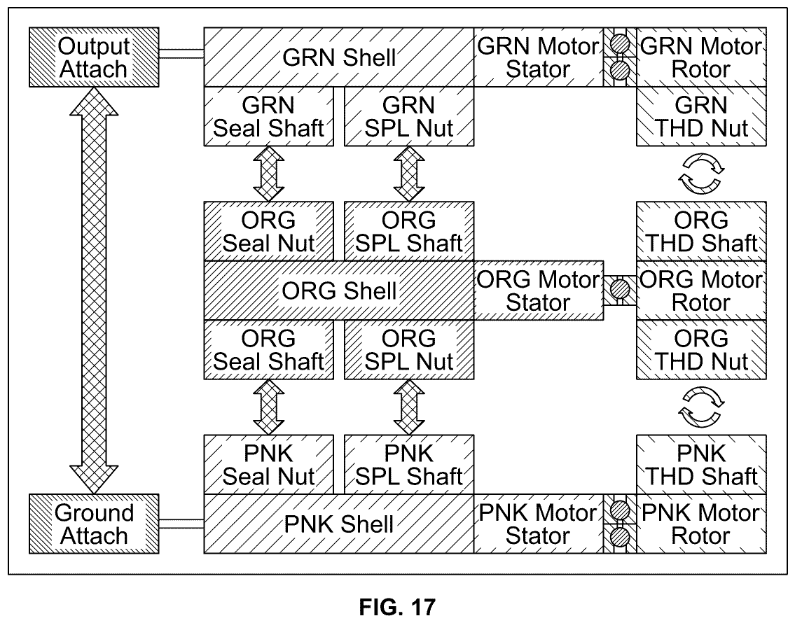

As generally discussed, consistent with embodiments of the present disclosure, a linear actuator may provide series redundancy that may allow operation of the linear actuator in the event of a failure condition. Referring also to FIG. 17, a block diagram of an example embodiment of a linear actuator consistent with the present disclosure is shown. As shown, the actuator may generally include three “units.” In particular, the actuator may include a “pink” unit including a shell that is attached to ground (e.g., a linear actuator housing or other base structure). The pink shell may include a spline shaft (e.g., a feature including spline features for mating with cooperating spline features) and seal nut for sealing against a cooperating shell. The pink shell may further include a motor stator rotationally coupled with a motor rotor that may rotationally actuate a threaded shaft. An “orange” unit may include an orange shell that may include a spline nut (e.g., spline features that may mate with the pink spline shaft) and a seal shaft for sealing with the pink seal nut. The orange shell may also include a seal nut for sealing with a cooperating shell and a spline shaft for mating with a cooperating spline nut. The orange shell may further include a motor stator that is rotationally coupled with a motor rotor for rotationally actuating both an orange thread nut (e.g., an internal thread that may form a first threaded interface with the pink threaded shaft). Further, a “green” unit may include a green shell. The green shell may include a seal shaft for sealing with the orange seal nut. The green shell may also include a spline nut for making with the orange spline shaft. Further, the green shell may include a motor stator that may be rotationally coupled with a motor rotor for rotationally actuating a green thread nut, which may form a second threaded interface with the orange threaded shaft. The green shell may also be coupled with an actuator output.

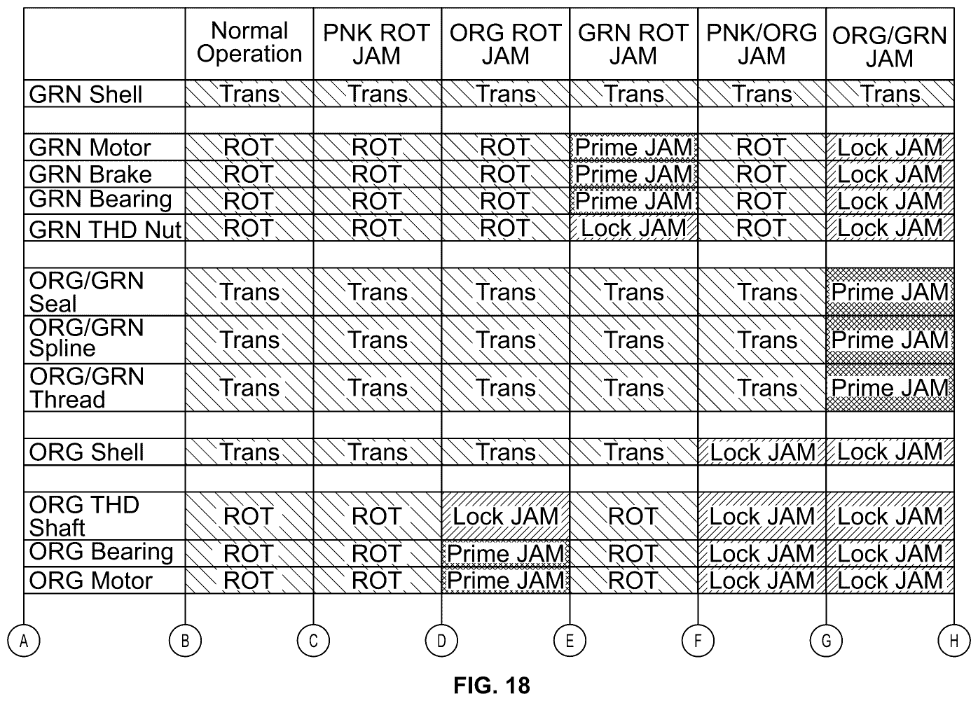

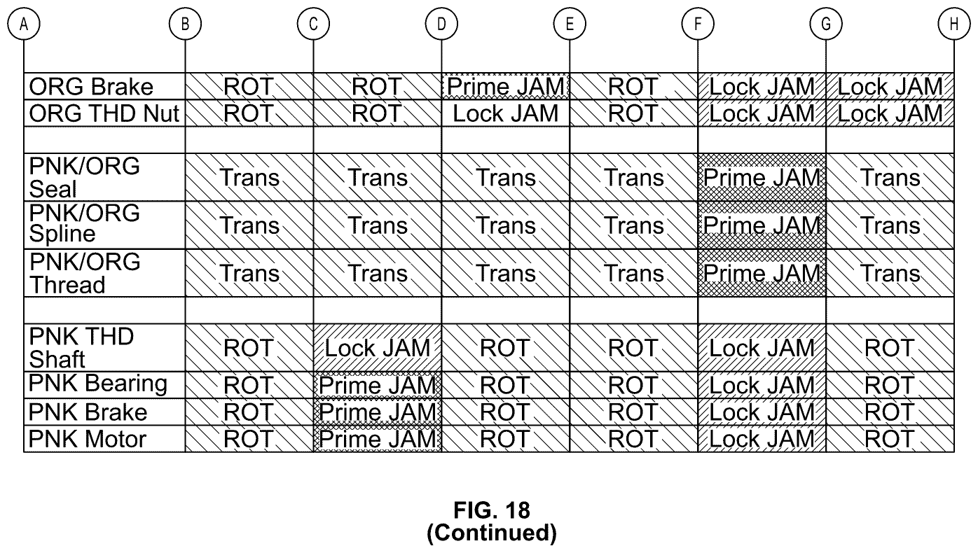

Consistent with the example actuator of FIG. 17, and with additional reference to FIG. 18, the linear actuator may experience five different failure states, encompassing two general failure types and/or combinations of two general failure types. A first failure type may include a sliding jam, such as at a spline, thread, or seal, which may have similar effects. A sliding jam may generally bind two shells together in translation (i.e., the two shells cannot elongate or telescope with respect to each other). However, the motors of the two jammed shells can still turn together to rate a function threaded interface. A second failure type may include a rotary jam, such as at a bearing, a brake, or a motor, all of which may be generally equivalent. A rotary jam may prevent one side of a threaded interface to rotate but may still allow translation by rotating the other side of the threaded interface to rotate. Accordingly, the five failure states may include: a pink rotational jam, an orange rotational jam, a green rotational jam, a pink/orange sliding jam, and an orange/green sliding jam, as illustrated in FIG. 18.

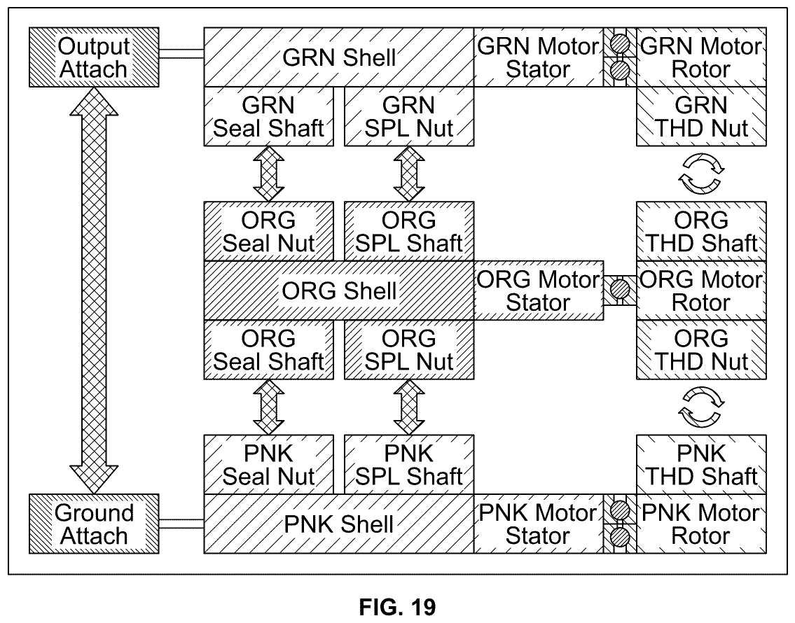

Referring to FIG. 19, a block diagram of a linear actuator during normal operation is generally depicted. As shown, when each of the functional units are operational, the pink unit and orange units may slide, or translate, with respect to each other, and the orange and green units may similarly slide, or translate with respect to each other. Additionally, the rotational aspects of each of the functional units may provide free rotation and may rotationally interact with cooperating units. For example, the pink threaded shaft may rotate, and the first threaded interface between the pink threaded shaft and the orange nut may be capable of rotational interaction. Similarly, the orange rotational component may rotate, and the first threaded interface between the orange nut and the pink threaded shaft may be capable of rotational interaction, and the second threaded interface between the orange threaded shaft and the green nut may be capable of rotational interaction. Further, the green nut may rotate, and the second threaded interface between the green nut and the orange threaded shaft may be capable of rotational interaction.

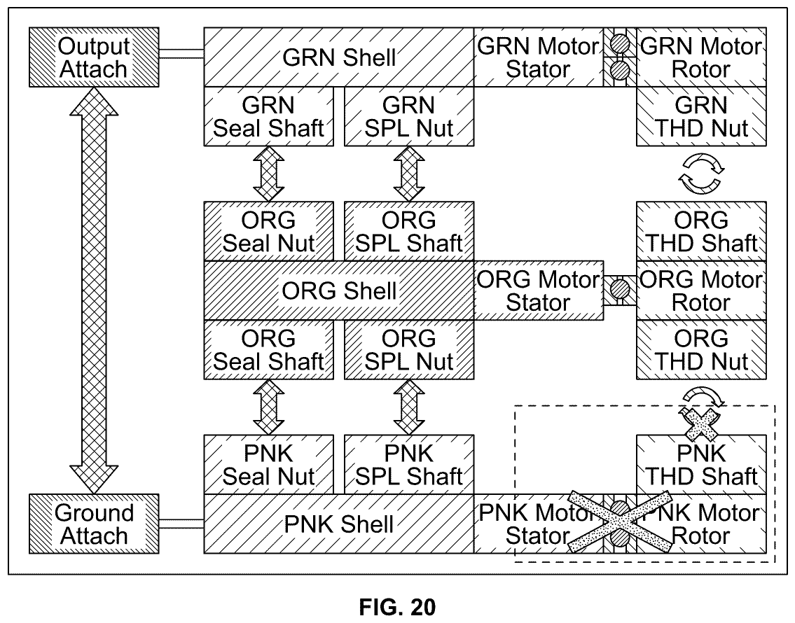

Referring to FIG. 20, a block diagram of a linear actuator experiencing a pink rotary jam failure mode is diagrammatically depicted. In the depicted example, the pink threaded shaft may not be able to rotate relative to ground (for example, due to a motor failure, a jammed or seized rotational component such as a bearing, brake, etc.) but the pink threaded shaft may be fixed for the orange threaded nut to turn against. Consistent with some such failure modes the orange and green shells may still have normal full travel. Therefore, for a given output (linear force and slew), while in normal operating conditions the linear actuator may have a 3× equal motor power distribution (33% each motor), in the depicted failure state this power distribution may change to 2× equal (50% each provided by the orange motor and the green motor). In some such circumstances, this may require ORG and GRN motors to increase speed by 16.6% (from baseline speed distribution). In some implementations, because the ORG motor turns against 2× threads (e.g., against the pink threaded shaft and the green threaded nut) so that the 1× speed of extension from ORG requires ½× motor speed. This may also mean that the same linear force requires 2× ORG motor torque.

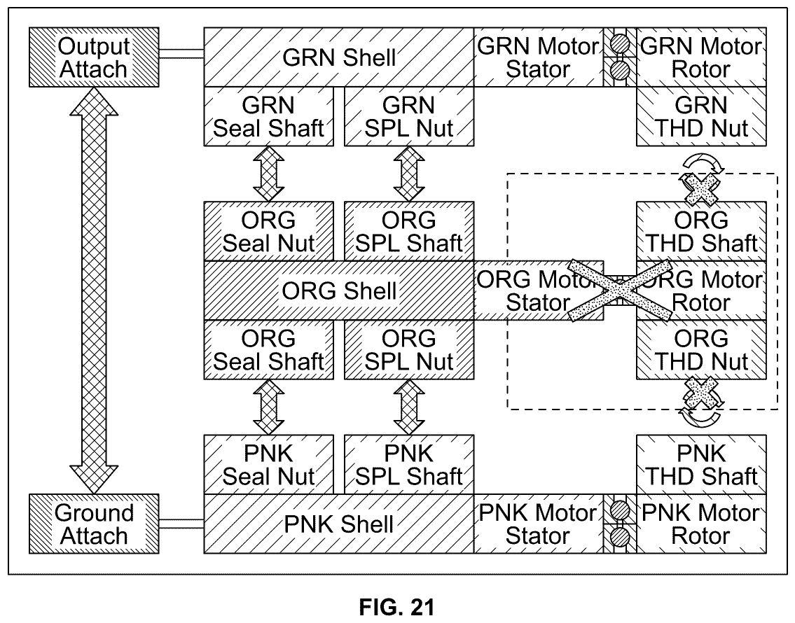

Referring to FIG. 21, a block diagram of a linear actuator experiencing an orange rotary jam failure mode is diagrammatically depicted. The orange rotary jam may result from, for example, an orange motor failure, a jammed or seized bearing, motor, brake, etc. In an orange rotary failure mode, one or more of orange bearing, motor, brake, and thread (including orange threaded nut and orange threaded shaft) may be fixed to ground (i.e., non-rotatable relative to ground). In this failure state, both ORG-Threaded-Nut and ORG-Threaded-Shaft may not be able to rotate relative to ground, but they may be fixed for GRN and PNK to rotate against. For example, the ORG shell still travels (e.g., slides or translates relative to the pink shell), and the GRN shell may also travel (e.g., slide or translate relative to ground and/or relative to the ORG shell). For a given output (linear force and slew), in normal operation conditions the linear actuator may provide 3× equal motor power distribution (33% each motor). In the orange rotary jam failure mode, this may change to 2× equal (50% each PNK and GRN). This may imply PNK and GRN motors may increase speed by 16.6% (from baseline speed distribution).

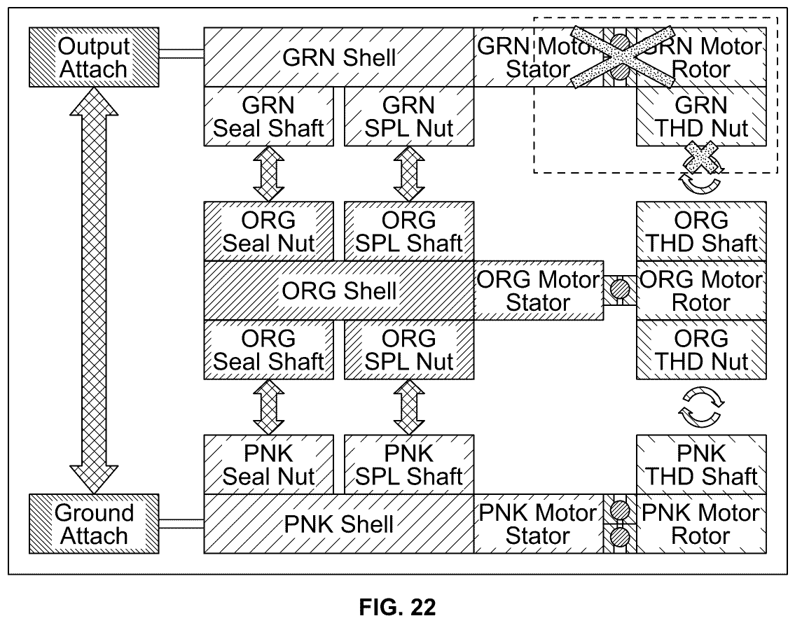

Referring to FIG. 22, a block diagram of a linear actuator experiencing a green rotary jam failure mode is diagrammatically depicted. In the green rotary jam condition, one or more of the green motor, bearing, brake, or thread may be rotationally fixed to ground. That is, for example, the GRN-threaded-nut may not be able to rotate relative to ground but may be fixed for the ORG-Threaded-Shaft to turn against. In this condition, the orange and green shells may still have normal full travel (e.g., the green and orange shells may be able to slide, or translate, relative to one another). For a given output (linear force and slew), in a normal operating condition there may be a 3× equal motor power distribution (33% each motor). However, in the green rotary jam condition this may change to 2× equal (50% each orange and pink). This may imply that ORG and PNK motors may need to increase speed by 16.6% (from baseline speed distribution) to produce the same output as a normal operating condition. For example, ORG motor turns against 2× threads (e.g., the pink threaded shaft and the green threaded nut) so that the 1× speed of extension from ORG requires ½× motor speed. This may also mean that same linear force requires 2× ORG motor torque.

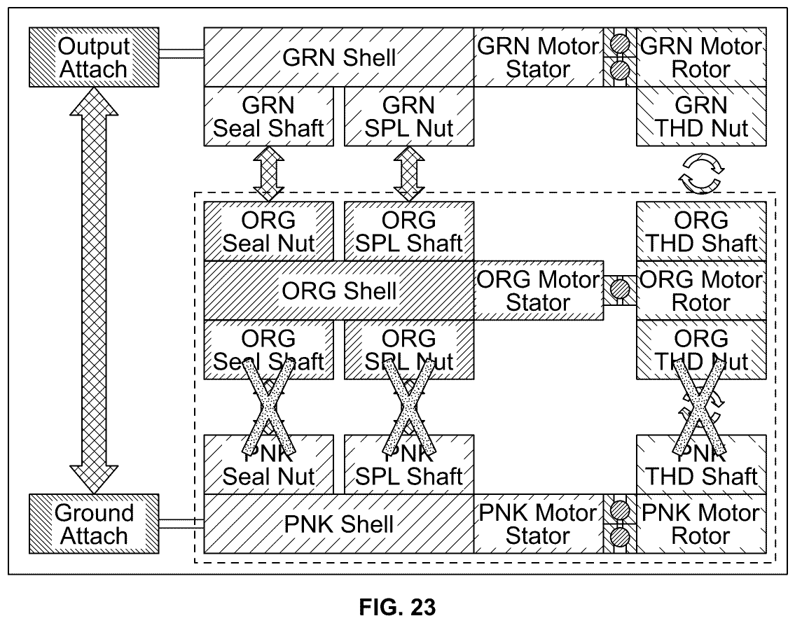

Referring to FIG. 23, a block diagram of a linear actuator experiencing a pink/orange jam failure mode id diagrammatically depicted. In some situations, the pink/orange jam may inhibit PNK/ORG relative translation and rotation. However, the pink and orange rotational components may still be capable of rotating together. For example, PNK and ORG motors may still turn together to rotate the ORG-threaded-shaft against the GRN-threaded-nut. In this situation it may still be possible to distribute motor power equally. For a given output (linear force and slew), the same force may be applied against 1× thread (e.g., the orange threaded shaft/green threaded nut interface), and may equal the same torque at GRN, but ORG and PNK may now be torque summing. For example, the linear actuator may experience speed summing between GRN and ORG-lock-PNK. The same power at all 3 motors may imply GRN speed and torque stay same, ORG-locked-PNK 2× speed, ½× torque from each motor.

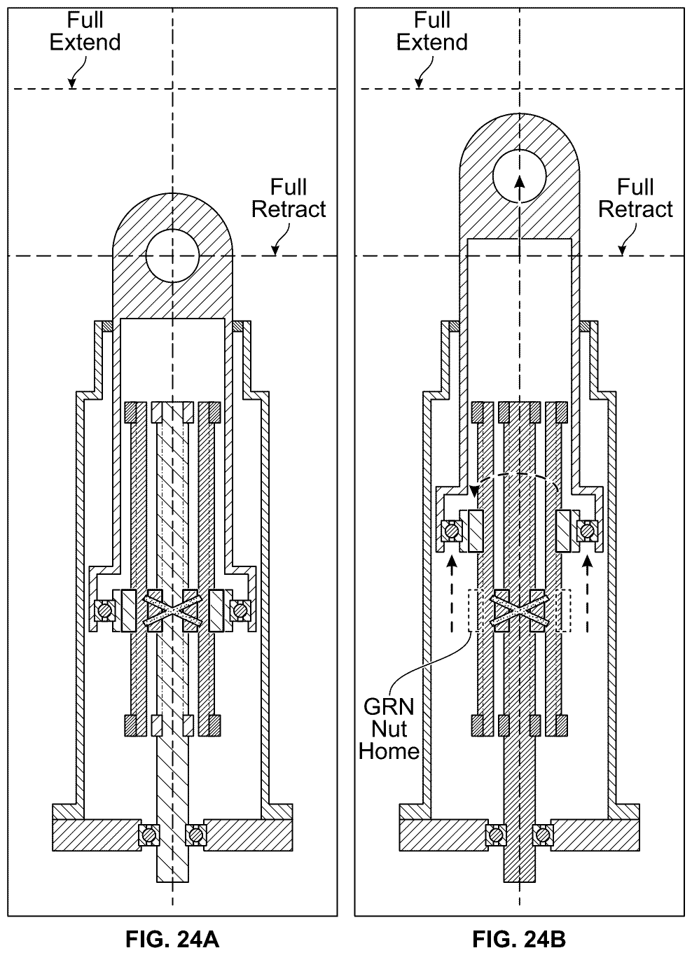

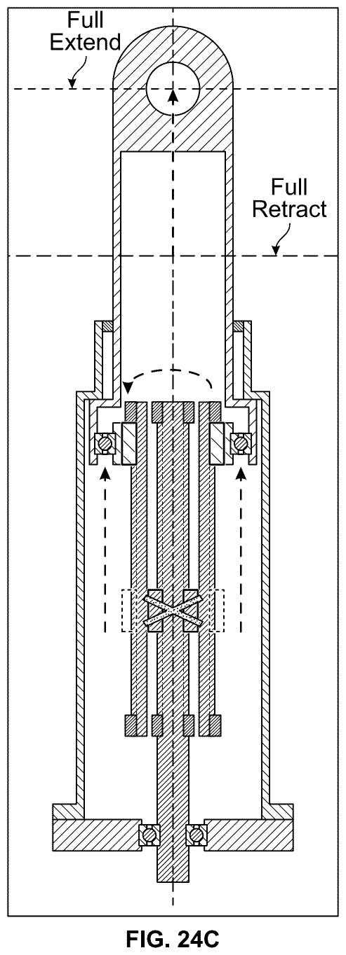

Referring to FIGS. 24A-24C, operation of a linear actuator experiencing a PNK/ORG thread jam from a retracted position of the linear actuator is diagrammatically depicted. In the depicted scenario, output of the linear actuator may include all ORG/GRN travel. If the pink-to-orange thread jams, then the orange nut and thread shell may not be able travel relative to the pink shaft. However, the green nut may have enough threaded travel on the stationary orange shell (e.g., orange threaded shaft portion of the second threaded interface) for full extension of the linear actuator. “GRN Nut Home” may be the starting location on the orange shaft.

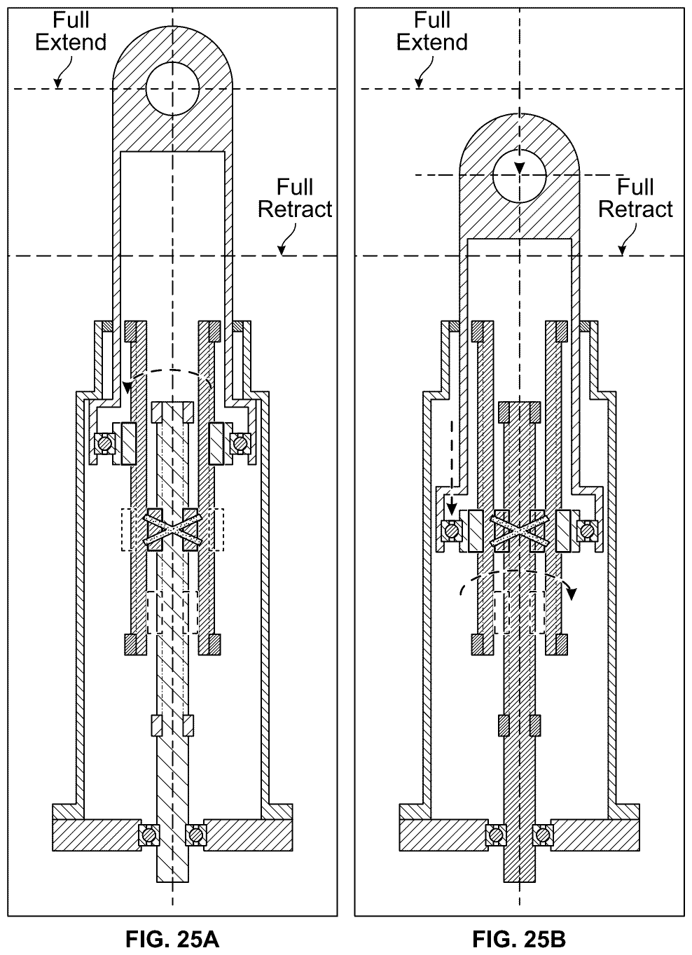

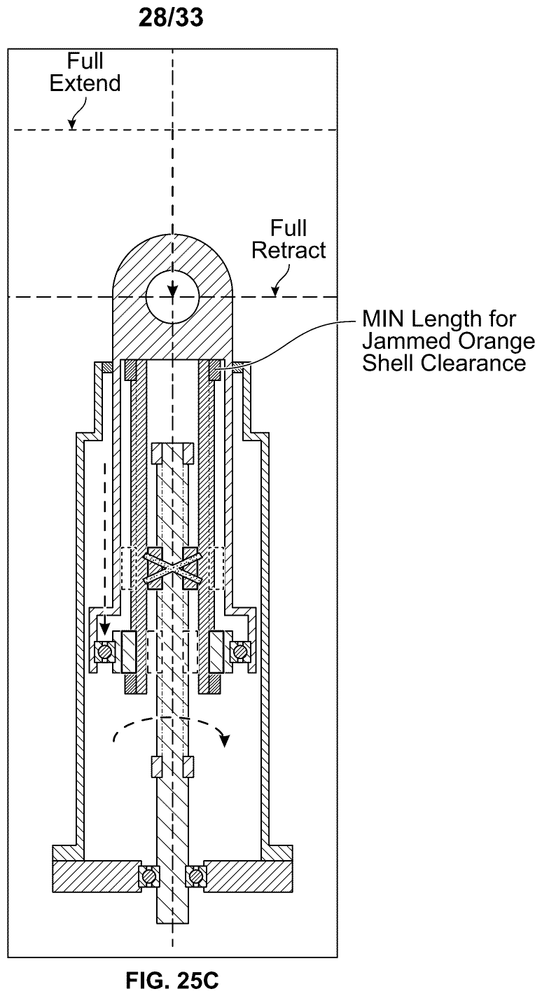

In a related case, and referring to FIGS. 25A-25C, operation of a linear actuator experiencing a PNK/ORG thread jam from an extended position is diagrammatically depicted. In the depicted scenario, output of the linear actuator may include all ORG/GRN travel. If a jam happens between the orange nut and the pink shaft when at max extension of the linear actuator, then the green nut may still be able to fully retract the linear actuator. The orange shell may become fused with the pink shaft at it's current location. That is, the orange shell is jammed sticking up (in the extended position of the linear actuator), so the blue shell (actuator output) length may be sufficient to clear the orange shell (e.g., as shown in FIG. 25C). In an example embodiment, this may end up being ½ full travel clearance being needed in the blue shell. Turning the green nut may retract the linear actuator, but in a situation in which Active-Active operation is utilized (e.g., green motor active and combined orange-pink motors active to rotate the orange shell), and the movement forward was only ½ of the total travel, then only ½ full travel may be required in reserve to retract the thread. This section of thread may only be used in a fault condition.

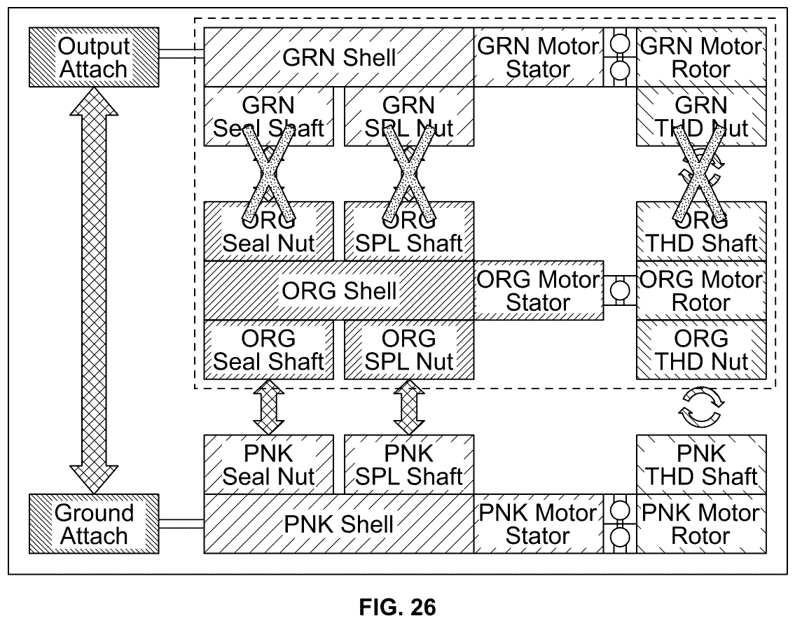

Referring to FIG. 26, a block diagram of a linear actuator experiencing an orange/green jam is diagrammatically depicted. In the depicted orange/green jam, ORG/GRN relative translation and rotation may be locked, but orange threaded shaft and green threaded nut may still rotate together. In such a situation, ORG and GRN motors can still turn together to rotate the ORG-threaded-nut against the PNK-threaded-shaft. In a similar manner as the PNK/ORG jam, it may still be possible to distribute motor power equally among the three motors. For example, for a given output (linear force and slew), the same force may be applied against 1× thread (e.g., the PNK/ORG threaded interface), which may equal the same torque at GRN but ORG and PNK may now experience torque summing. Speed summing may occur between GRN and ORG-locked-PNK. As such, the same power at all 3 implies GRN motor may operate at 1× speed. 1× torque may be applied by ORG-locked-PNK with 2× speed*½× torque.

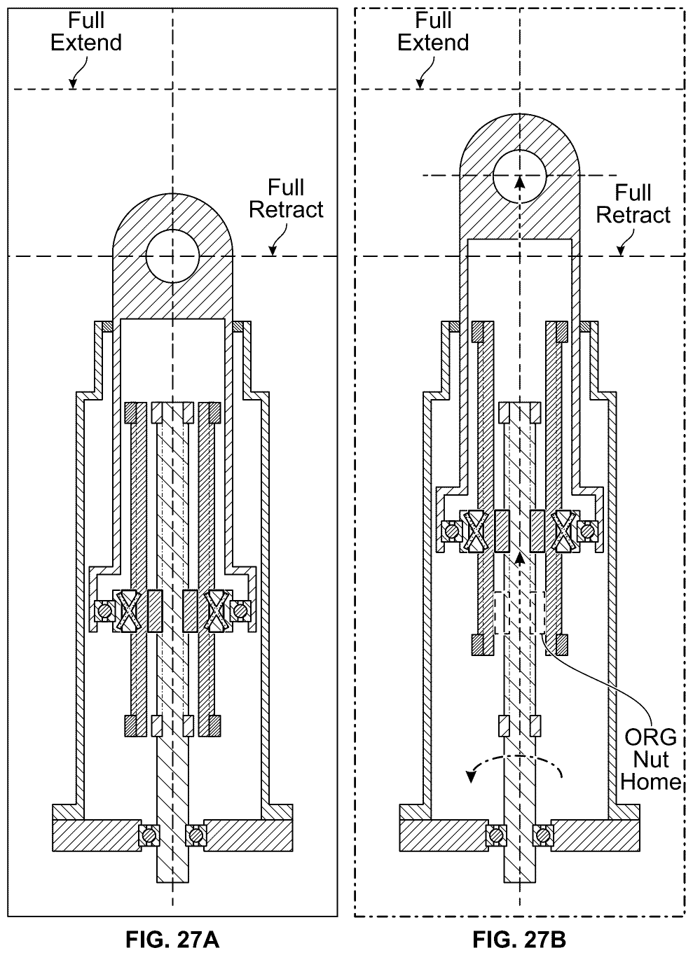

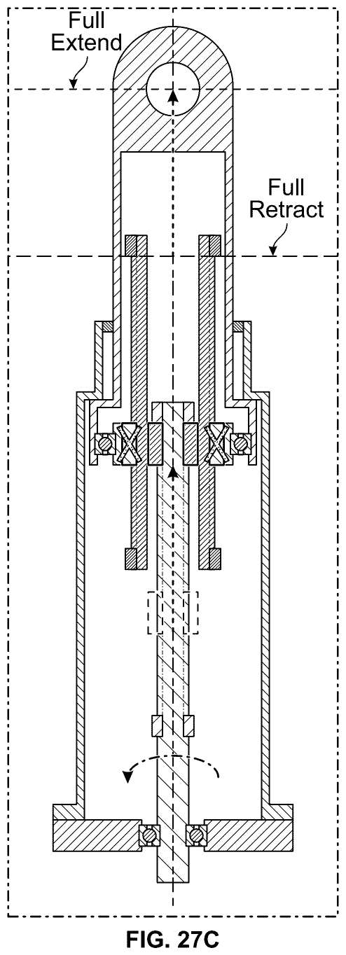

A specific case of an ORG/GRN thread jam of the linear actuator is diagrammatically depicted with reference to FIGS. 27A-27C. In the depicted scenario, operation of the linear actuator may occur through the PNK/ORG threaded interface. For example, if the orange-to-green thread jams, then the orange nut and threaded shell may not be able to travel relative to the green nut but may still be able to travel relative to the pink shaft. The non-rotating orange nut may have enough threaded travel on the pink shaft to reach full travel of the linear actuator. “ORG Nut Home” may be the starting location on the pink shaft.

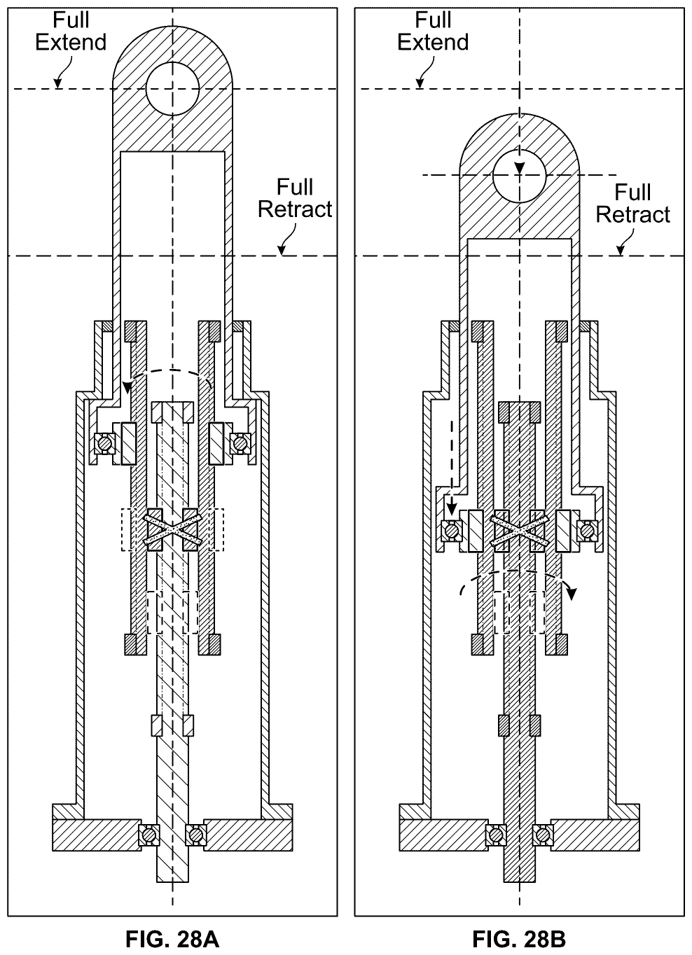

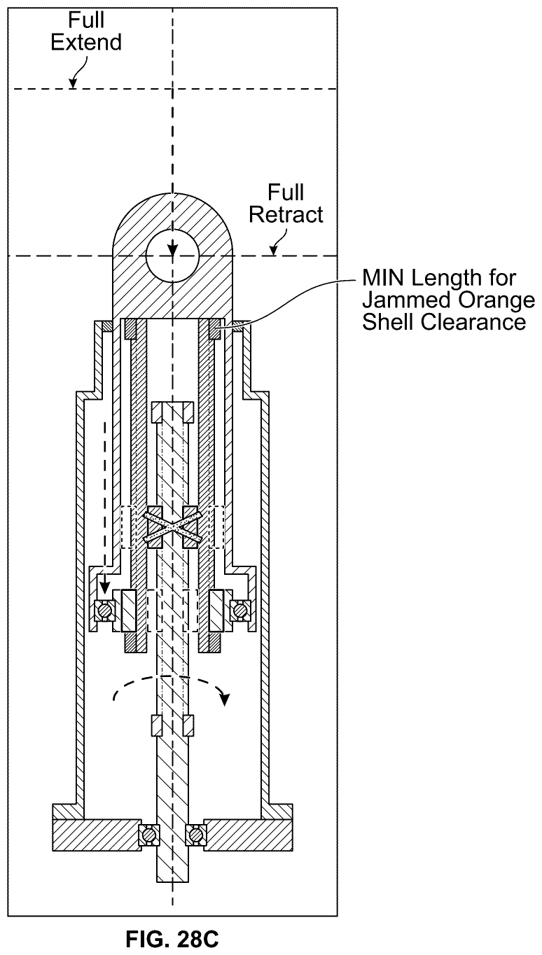

In a related failure scenario, an ORG/GRN thread jam at full extension is diagrammatically depicted with reference to FIGS. 28A-28C. In such a failure scenario, operation of the linear actuator may occur through the PNK/ORG threaded interface. If a jam happens between the green nut and the orange shaft when the linear actuator is at max extension, then the orange nut may still be able to fully retract. For example, if the green shell becomes fused with the orange shell at it's current relative location, the orange shell may need to retract by 1× full travel. As such, the linear actuator may be provided with enough retract clearance to prevent impact on the gray base. This may equate to ½ full travel being required for reserve clearance. Turning the pink shaft may retract the orange nut. Through the use Active-Active operation (e.g., the pink motor rotating the pink shaft and the orange and green motors rotating the orange nut/threaded shaft and green nut together), the movement forward may only be ½ of the total travel. As such, the linear actuator may only require ½ full travel in pink reserve retract thread. This section of pink thread may typically only be used in a fault condition.

Herein various embodiments, and implementations have been discussed, including various individual features and combinations of features. It will be appreciated that various additional and/or alternative embodiments may be realized consistent with the foregoing description. For example, the features, aspects, advantages, and/or attributes of the variously described embodiments and implementations may be provided in combinations in addition to those specifically discussed. Similarly, various features, aspects, and/or attributes of one embodiment or implementation may be utilized in connection with one or more other embodiments and/or implementations. All such combinations and modifications are considered to be within the scope of the present disclosure. As such, any inventive concepts herein should not be limited by the specifically described embodiments and implementations.

What is claimed is:

1. A linear actuator comprising:
a first actuator member;
a second actuator member;
a third actuator member;
a first threaded interface between the first actuator member and the second actuator member configured to produce relative linear movement of the first actuator member and the second actuator member along an actuation direction during rotational actuation of the first threaded interface; and
a second threaded interface between the second actuator member and the third actuator member configured to produce relative linear movement of the second actuator member and the third actuator member along the actuation direction during rotational actuation of the second threaded interface.

2. The linear actuator of claim 1, wherein the first threaded interface includes an external thread associated with the first actuator member and an internal thread associated with the second actuator member.

3. The linear actuator of claim 1, wherein the second threaded interface includes an external thread associated with the second actuator member and an internal thread associated with the third actuator member.

4. The linear actuator of claim 1, wherein the first threaded interface and the second threaded interface include opposite thread directions.

5. The linear actuator of claim 1, wherein the first threaded interface and the second threaded interface are coaxial.

6. The linear actuator of claim 1, wherein the first threaded interface includes a ball screw interface.

7. The linear actuator of claim 1, wherein the second threaded interface includes a ball screw interface.

8. The linear actuator of claim 1, wherein the first threaded interface and the second threaded interface include a compound coaxial ball screw associated with the second actuator member.

9. The linear actuator of claim 8, wherein the compound coaxial ball screw includes two independent ball circuits including:
an inner ball circuit forming at least a portion of the first threaded interface with the first actuator member; and
an outer ball circuit forming at least a portion of the second threaded interface with the third actuator member.

10. The linear actuator of claim 1, further comprising one or more of:
a first rotational actuator for rotating the first actuator member;
a second rotational actuator for rotating the second actuator member; and
a third rotational actuator for rotating the third actuator member.

11. The linear actuator of claim 10, further comprising one or more of:
a first carrier mounting the first rotational actuator;
a second carrier mounting the second rotational actuator; and
a third carrier mounting the third rotational actuator.

12. The linear actuator of claim 11, wherein the first carrier, the second carrier, and the third carrier are mutually telescoping along the actuation direction.

13. The linear actuator of claim 11, wherein:
the first carrier is rotationally constrained relative to the second carrier; and
the second carrier is rotationally constrained relative to the third carrier.

14. A linear actuator comprising:
an at least partially threaded shaft rotationally drivable by a first rotational actuator;
an intermediate shell rotationally drivable by a second rotational actuator, the intermediate shell including:
an at least partially threaded interior opening forming a first threaded interface with the at least partially threaded shaft; and
an at least partially threaded exterior component;
an outer shell rotationally drivable by a third rotational actuator, the outer shell having an at least partially threaded interior opening forming a second threaded interface with the at least partially threaded exterior component of the intermediate shell.

15. The linear actuator of claim 14, wherein the first threaded interface and the second threaded interface include opposite thread directions.

16. The linear actuator of claim 14, wherein the at least partially threaded interior opening of the intermediate shell includes a nut forming the first threaded interface with the at least partially threaded shaft.

17. The linear actuator of claim 14, wherein the at least partially threaded interior opening of the outer shell includes a nut forming the second threaded interface with the at least partially threaded exterior component of the intermediate shell.

18. The linear actuator of claim 14, wherein the intermediate shell includes a compound coaxial ball screw including:
an inner ball circuit forming at least a portion of the first threaded interface with the at least partially threaded shaft; and
an outer ball circuit forming at least a portion of the second threaded interface with the third actuator member.

19. The linear actuator of claim 14, further comprising:
a first carrier mounting the first rotational actuator;
a second carrier mounting the second rotational actuator; and
a third carrier mounting the third rotational actuator;
wherein the first carrier is rotationally constrained relative to the second carrier; and
wherein the second carrier is rotationally constrained relative to the third carrier.

20. The linear actuator of claim 19, wherein:
the first carrier and the second carrier include a telescoping splined interface; and
the second carrier and the third carrier include a telescoping splined interface.
